(19) United States
(12) Patent Application Publication
(10) Pub. No.: US 2023/0108722 A1
(43) Pub. Date: Apr. 6, 2023

(54) ALLOCATING BIT RATE BETWEEN VIDEO STREAMS USING MACHINE LEARNING

(71) Applicant: Microsoft Technology Licensing, LLC, Redmond, WA (US)

(72) Inventors: Satya Sasikanth BENDAPUDI, Bellevue, WA (US); Ming-Chieh LEE, Bellevue, WA (US); Yan LU, Beijing (CN); Bin LI, Beijing (CN); Jiahao LI, Beijing (CN)

(73) Assignee: Microsoft Technology Licensing, LLC, Redmond, WA (US)

(21) Appl. No.: 17/492,505

(22) Filed: Oct. 1, 2021

(51) Int. Cl. H04N 19/147; H04N 19/152; H04N 19/172; H04N 19/124; G06N 20/00

(52) U.S. Cl. CPC H04N 19/147; H04N 19/152; H04N 19/172; H04N 19/124; G06N 20/00

(57) ABSTRACT

Innovations in allocation of bit rate between video streams using machine learning are described. For example, a controller of a video encoder system receives first feedback values that indicate results of encoding part of a first video sequence (e.g., screen content). The controller also receives second feedback values that indicate results of encoding part of a second video sequence (e.g., camera video content). A machine learning model accepts, as inputs, the first feedback values and second feedback values. The machine learning model produces, as output, a reallocation parameter. The controller determines a first target bit rate and a second target bit rate using the reallocation parameter. A first video encoder encodes one or more pictures of the first video sequence at the first target bit rate, and a second video encoder encodes one or more pictures of the second video sequence at the second target bit rate.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last three decades, various video codec standards have been adopted, including the ITU-T H.261, H.262, H.263, H.264, and H.265 standards, the MPEG-1 and MPEG-4 Visual standards, the SMPTE 421M (VC-1) standard, and the AV1 standard. More recently, the ITU-T H.266 standard has been under development. A video codec standard typically defines options for the syntax of an encoded video bitstream, detailing parameters in the bitstream when particular features are used in encoding and decoding. In many cases, a video codec standard also provides details about the decoding operations a decoder should perform to achieve conforming results in decoding. Aside from codec standards, various proprietary codec formats define other options for the syntax of an encoded video bitstream and corresponding decoding operations.

When compressing video content, a video encoder converts the video content into a lower bit rate form. To reduce the bit rate of the encoded data, a video encoder can lower the resolution of the video content in various ways. For example, a video encoder can compress video content at a lower frame rate, so that the video content is represented using fewer frames per second (e.g., 10 frames per second instead of 30 frames per second). Lowering the frame rate of video content tends to reduce bit rate, but motion in the reconstructed video content may appear choppy. As another example, a video encoder can compress video content at a lower spatial resolution, with a given frame of the video content being represented using fewer pixel values (e.g., 800×600 pixel values per frame instead of 1600×1200 pixel values per frame). Lowering the spatial resolution of video content tends to reduce bit rate, but the reconstructed video content may lack fine details such as textures. As another example, a video encoder can represent different types of data more “coarsely” (with fewer possible values) to reduce bit rate (e.g., using 16 possible values instead of 256 possible values). Representing data more coarsely tends to reduce bit rate, but the reconstructed video content may be blurry, have perceptible boundaries between blocks, have blotches of colors instead of smooth gradations, and/or otherwise show perceptible flaws introduced by compression.

Some video encoders are adapted for compression of “artificially” created video content such as screen content (also called screen capture content). Common scenarios for compression of screen content include remote desktop conferencing and screen sharing. Other video encoders are adapted for compression of “natural” video captured with a camera. Common scenarios for compression of camera video include video conferencing and video calls.

In scenarios such as desktop conferencing and video collaboration meetings, a stream of screen content and one or more streams of camera video content may be compressed and transmitted from one site. The multiple video streams may share the available network bandwidth, which may be insufficient for all of the video streams to consistently have high quality. Screen content often includes details (e.g., text, graphics) for which degradation in quality (e.g., blurring) is especially noticeable and disruptive. Moreover, screen content is typically important for collaboration. As such, the quality of the screen content stream is usually prioritized over the quality of the camera video stream(s).

In some prior approaches, a fixed amount of bit rate, large enough to allow high quality of reconstruction, is reserved for the screen content stream. This can cause sub-optimal quality in the camera video stream(s) when network bandwidth is limited, even if the screen content stream does not currently use all of the bit rate reserved to it. Such prior approaches are inflexible about the amount of bit rate reserved for the screen content stream.

### SUMMARY

In summary, the detailed description presents innovations in allocation of bit rate between video streams using machine learning. The innovations can be used in real-time encoding scenarios when encoding screen content and camera video content for a desktop conferencing application, collaboration application, or other application. In some cases, the innovations allow a video encoder system to allocate unused bit rate from a first video encoder to a second video encoder, and then allocate the bit rate back to the first video encoder as needed. For example, in some cases, a video encoder system can detect when a screen content encoder is not using all of the bit rate allocated to it and can reallocate unused bit rate to a camera video encoder, thereby improving the quality of the compressed camera video content without hurting the quality of the compressed screen content.

According to one aspect of the innovations described herein, a controller of a video encoder system receives first feedback values that indicate results of encoding part of a first video sequence (e.g., screen content). The controller also receives second feedback values that indicate results of encoding part of a second video sequence (e.g., camera video content). A machine learning model accepts, as inputs, the first feedback values and the second feedback values. The machine learning model produces, as output, a reallocation parameter. For example, the reallocation parameter is a shift ratio that indicates bit rate to reallocate from encoding of the first video sequence to encoding of the second video sequence. The controller determines a first target bit rate and a second target bit rate using the reallocation parameter. A first video encoder encodes one or more pictures of the first video sequence at the first target bit rate, and a second video encoder encodes one or more pictures of the second video sequence at the second target bit rate. In this way, in many cases, the video encoder system can effectively reallocate unused bit rate from the first video encoder to the second video encoder, then return the bit rate to the first video encoder when needed.

According to another aspect of the innovations described herein, a machine learning model (e.g., neural network) for allocating bit rate between video streams is trained using actor-critic reinforcement learning. In each of multiple iterations of the training process, a controller performs various operations. The controller receives first feedback values that indicate results of encoding part of a first video sequence. The controller also receives second feedback values that indicate results of encoding part of a second video sequence. As part of an actor path of the machine learning model, the controller determines a reallocation parameter and then determines a first target bit rate and a second target bit rate using the reallocation parameter. One or more pictures of the first video sequence are encoded at the first target bit rate, and one or more pictures of the second video sequence are encoded at the second target bit rate. As part of a critic path of the machine learning model, the controller calculates a value of a reward function based on assessment of the reallocation parameter. The controller selectively adjusts the machine learning model based on the value of the reward function. In this way, the video encoder system can effectively train the machine learning model to detect when a first video encoder is not using all of the bit rate allocated to it and reallocate the unused bit rate to a second video encoder.

The innovations for allocation of bit rate between video streams using a machine learning model can be implemented as part of a method, as part of a computer system configured to perform the method, or as part of a tangible computer-readable media storing computer-executable instructions for causing one or more processors, when programmed thereby, to perform the method. The various innovations can be used in combination or separately. The innovations described herein include, but are not limited to, the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a diagram illustrating an example computer system in which some described embodiments can be implemented.

FIGS. 2a and 2b are diagrams illustrating example network environments in which some described embodiments can be implemented.

FIG. 3 is a diagram illustrating an example video encoder system, including multiple types of video encoders and a rate controller, in which some described embodiments can be implemented.

FIG. 4 is a diagram illustrating an example video encoder system in conjunction with which some described embodiments can be implemented.

FIGS. 5a and 5b are diagrams illustrating an example video encoder in conjunction with which some described embodiments can be implemented.

FIGS. 6 and 7 are diagrams illustrating example machine learning models configured to determine a parameter for allocating bit rate between video streams.

FIG. 8a is a flowchart illustrating a generalized technique for allocating bit rate between video streams using a machine learning model. FIG. 8b is a flowchart illustrating example operations for determining target bit rates using a reallocation parameter from the machine learning model.

FIG. 9 is a diagram illustrating a machine learning model configured for training, with actor-critic reinforcement learning, to determine a parameter for allocating bit rate between video streams.

FIG. 10 is a flowchart illustrating a generalized technique for training, using actor-critic reinforcement learning, a machine learning model to determine a parameter for allocating bit rate between video streams.

### DETAILED DESCRIPTION

The detailed description presents innovations in allocation of bit rate between video streams using machine learning. For example, a controller of a video encoder system receives first feedback values that indicate results of encoding part of a first video sequence (e.g., screen content). The controller also receives second feedback values that indicate results of encoding part of a second video sequence (e.g., camera video content). A machine learning model accepts the first and second feedback values as inputs. The machine learning model produces a reallocation parameter as output. The controller determines a first target bit rate and a second target bit rate using the reallocation parameter. A first video encoder encodes one or more pictures of the first video sequence at the first target bit rate, and a second video encoder encodes one or more pictures of the second video sequence at the second target bit rate. In this way, in many cases, the video encoder system can effectively reallocate unused bit rate from the first video encoder to the second video encoder, then return the bit rate to the first video encoder when needed. The innovations can be used in real-time encoding scenarios when encoding screen content and camera video content for a desktop conferencing application, collaboration application, or other application. In particular, in some example implementations, a video encoder system can detect when a screen content encoder is not using all of the bit rate allocated to it and can reallocate unused bit rate to a camera video encoder, thereby improving the quality of the compressed camera video content without hurting the quality of the compressed screen content.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. Example Computer Systems.

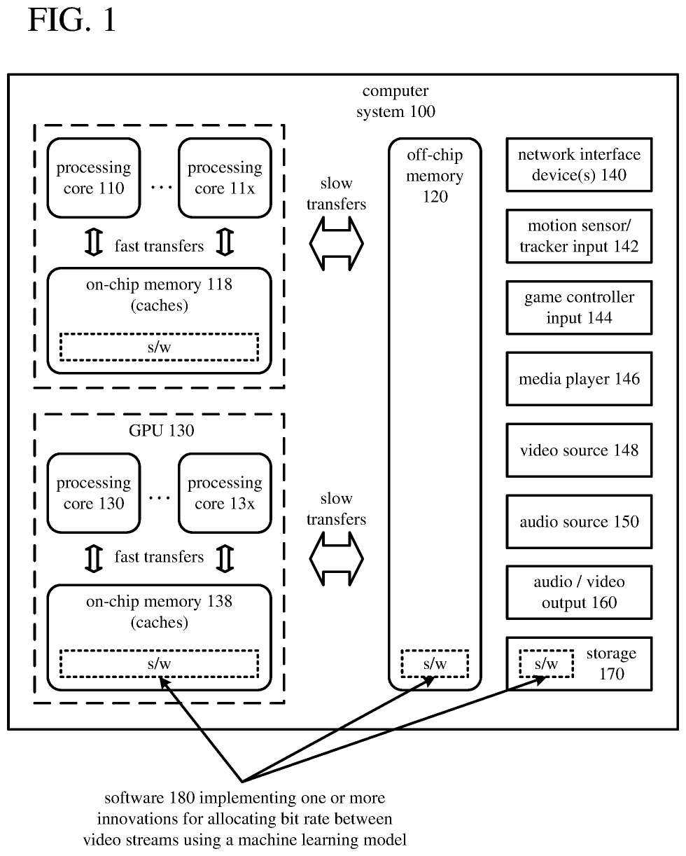

FIG. 1 illustrates a generalized example of a suitable computer system (100) in which several of the described innovations may be implemented. The innovations described herein relate to allocation of bit rate between video streams using machine learning. Aside from its use in allocation of bit rate between video streams using machine learning, the computer system (100) is not intended to suggest any limitation as to scope of use or functionality, as the innovations may be implemented in diverse computer systems, including special-purpose computer systems adapted for video encoding.

With reference to FIG. 1, the computer system (100) includes one or more processing cores (110 . . . 11x) and local memory (118) of system-on-a-chip (“SoC”), application-specific integrated circuit (“ASIC”), central processing unit (“CPU”), or other integrated circuit. The processing core(s) (110 . . . 11x) are, for example, processing cores on a single chip, and execute computer-executable instructions. The number of processing core(s) (110 . . . 11x) depends on implementation and can be, for example, 4 or 8. The local memory (118) may be volatile memory (e.g., registers, cache, RAM), non-volatile memory (e.g., ROM, EEPROM, flash memory, etc.), or some combination of the two, accessible by the respective processing core(s) (110 . . . 11x).

The local memory (118) can store software (180) implementing one or more innovations for allocation of bit rate between video streams using machine learning, for operations performed by the respective processing core(s) (110 . . . 11x), in the form of computer-executable instructions. In FIG. 1, the local memory (118) is on-chip memory such as one or more caches, for which access operations, transfer operations, etc. with the processing core(s) (110 . . . 11x) are fast.

The computer system (100) also includes processing cores (130 . . . 13x) and local memory (138) of a graphics processing unit (“GPU”). The number of processing cores (130 . . . 13x) of the GPU depends on implementation. The processing cores (130 . . . 13x) are, for example, part of single-instruction, multiple data (“SIMD”) units of the GPU. The SIMD width n, which depends on implementation, indicates the number of elements (sometimes called lanes) of a SIMD unit. For example, the number of elements (lanes) of a SIMD unit can be 16, 32, 64, or 128 for an extra-wide SIMD architecture. The local memory (138) may be volatile memory (e.g., registers, cache, RAM), non-volatile memory (e.g., ROM, EEPROM, flash memory, etc.), or some combination of the two, accessible by the respective processing cores (130 . . . 13x).

The local memory (138) can store software (180) implementing one or more innovations for allocation of bit rate between video streams using machine learning, for operations performed by the respective processing cores (130 . . . 13x), in the form of computer-executable instructions such as shader code. In FIG. 1, the local memory (138) is on-chip memory such as one or more caches, for which access operations, transfer operations, etc. with the processing cores (130 . . . 13x) are fast.

The computer system (100) includes shared memory (120), which may be volatile memory (e.g., RAM), non-volatile memory (e.g., ROM, EEPROM, flash memory, etc.), or some combination of the two, accessible by the processing core(s) (110 . . . 11x, 130 . . . 13x). The memory (120) stores software (180) implementing one or more innovations for allocation of bit rate between video streams using machine learning, in the form of computer-executable instructions. In FIG. 1, the shared memory (120) is off-chip memory, for which access operations, transfer operations, etc. with the processing cores (110 . . . 11x, 130 . . . 13x) are slower.

Alternatively, the computer system (100) includes one or more processing cores of a CPU and associated memory, without a GPU. The processing core(s) of the CPU can execute computer-executable instructions for one or more innovations for allocation of bit rate between video streams using machine learning.

More generally, the term “processor” may refer generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or a field-programmable gate array (“FPGA”).

The term “control logic” may refer to a controller or, more generally, one or more processors, operable to process computer-executable instructions, determine outcomes, and generate outputs. Depending on implementation, control logic can be implemented by software executable on a CPU, by software controlling special-purpose hardware (e.g., a GPU or other graphics hardware), or by special-purpose hardware (e.g., in an ASIC).

The computer system (100) includes one or more network interface devices (140). The network interface device(s) (140) enable communication over a network to another computing entity (e.g., server, other computer system). The network interface device(s) (140) can support wired connections and/or wireless connections, for a wide-area network, local-area network, personal-area network or other network. For example, the network interface device(s) can include one or more Wi-Fi transceivers, an Ethernet port, a cellular transceiver and/or another type of network interface device, along with associated drivers, software, etc. The network interface device(s) (140) convey information such as computer-executable instructions, audio or video input or output, or other data in a modulated data signal over network connection(s). A modulated data signal is a signal that has one or more of its characteristics set or changed in such a manner as to encode information in the signal. By way of example, and not limitation, the network connections can use an electrical, optical, RF, or other carrier.

The computer system (100) optionally includes a motion sensor/tracker input (142) for a motion sensor/tracker, which can track the movements of a user and objects around the user. For example, the motion sensor/tracker allows a user (e.g., player of a game) to interact with the computer system (100) through a natural user interface using gestures and spoken commands. The motion sensor/tracker can incorporate gesture recognition, facial recognition and/or voice recognition.

The computer system (100) optionally includes a game controller input (144), which accepts control signals from one or more game controllers, over a wired connection or wireless connection. The control signals can indicate user inputs from one or more directional pads, buttons, triggers and/or one or more joysticks of a game controller. The control signals can also indicate user inputs from a touchpad or touchscreen, gyroscope, accelerometer, angular rate sensor, magnetometer and/or other control or meter of a game controller.

The computer system (100) optionally includes a media player (146) and video source (148). The media player (146) can play DVDs, Blu-ray disks, other disk media and/or other formats of media. The video source (148) can be a camera input that accepts video input in analog or digital form from a video camera, which captures natural video. Or, the video source (148) can be a screen capture module (e.g., a driver of an operating system, or software that interfaces with an operating system) that provides screen capture content as input. Or, the video source (148) can be a graphics engine that provides texture data for graphics in a computer-represented environment. Or, the video source (148) can be a video card, TV tuner card, or other video input that accepts input video in analog or digital form (e.g., from a cable input, HDMI input or other input).

An optional audio source (150) accepts audio input in analog or digital form from a microphone, which captures audio, or other audio input.

The computer system (100) optionally includes a video output (160), which provides video output to a display device. The video output (160) can be an HDMI output or other type of output. An optional audio output (160) provides audio output to one or more speakers.

The storage (170) may be removable or non-removable, and includes magnetic media (such as magnetic disks, magnetic tapes or cassettes), optical disk media and/or any other media which can be used to store information and which can be accessed within the computer system (100). The storage (170) stores instructions for the software (180) implementing one or more innovations for allocation of bit rate between video streams using machine learning.

The computer system (100) may have additional features. For example, the computer system (100) includes one or more other input devices and/or one or more other output devices. The other input device(s) may be a touch input device such as a keyboard, mouse, pen, or trackball, a scanning device, or another device that provides input to the computer system (100). The other output device(s) may be a printer, CD-writer, or another device that provides output from the computer system (100).

An interconnection mechanism (not shown) such as a bus, controller, or network interconnects the components of the computer system (100). Typically, operating system software (not shown) provides an operating environment for other software executing in the computer system (100), and coordinates activities of the components of the computer system (100).

The computer system (100) of FIG. 1 is a physical computer system. A virtual machine can include components organized as shown in FIG. 1.

The term “application” or “program” may refer to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including but not limited to non-volatile media and volatile media. Non-volatile media include, for example, optical or magnetic disks and other persistent memory. Volatile media include dynamic random access memory (“DRAM”). Common forms of computer-readable media include, for example, a solid state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “computer-readable memory” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control a GPU or special-purpose hardware to provide functionality described herein, instructions executable on processing cores of a GPU to provide functionality described herein, and/or instructions executable on processing cores of a special-purpose processor to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and can include any combination of special-purpose hardware and/or hardware with software implementing the functionality described herein.

Numerous examples are described in this disclosure, and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular features of the disclosed innovations may be described with reference to one or more particular examples, it should be understood that such features are not limited to usage in the one or more particular examples with reference to which they are described, unless expressly specified otherwise. The present disclosure is neither a literal description of all examples nor a listing of features of the invention that must be present in all examples.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and can include any combination of special-purpose hardware and/or hardware with software implementing the functionality described herein.

Further, the techniques and tools described herein are not limited to the specific examples described herein. Rather, the respective techniques and tools may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps/stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and should not be confused with acts performed by a human being. The actual computer operations corresponding to these terms vary depending on implementation.

### II. Example Network Environments.

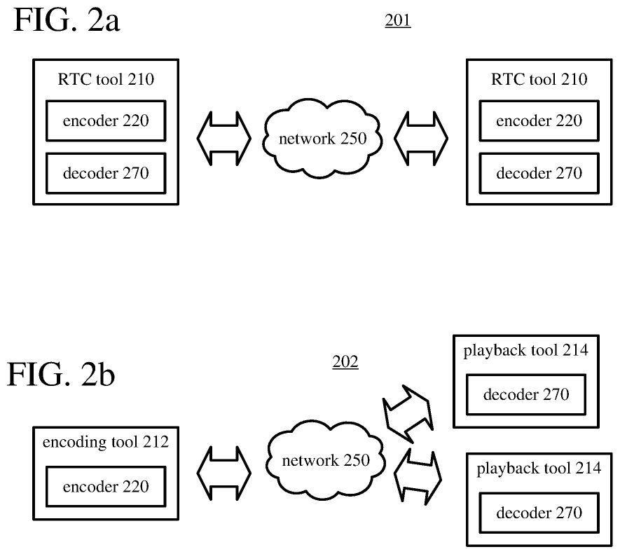

FIGS. 2a and 2b show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2a, each real-time communication (“RTC”) tool (210) includes both an encoder (220) and a decoder (270) for bidirectional communication. A given encoder (220) can produce output compliant with the AV1 standard, VP8 standard, VP9 standard, H.265 standard, H.264 standard, or a variation or extension thereof, or another codec standard or format, with a corresponding decoder (270) accepting encoded data from the encoder (220). The bidirectional communication can be part of a video conference, video telephone call, or other two-party or multi-party communication scenario. Although the network environment (201) in FIG. 2a includes two real-time communication tools (210), the network environment (201) can instead include three or more real-time communication tools (210) that participate in multi-party communication.

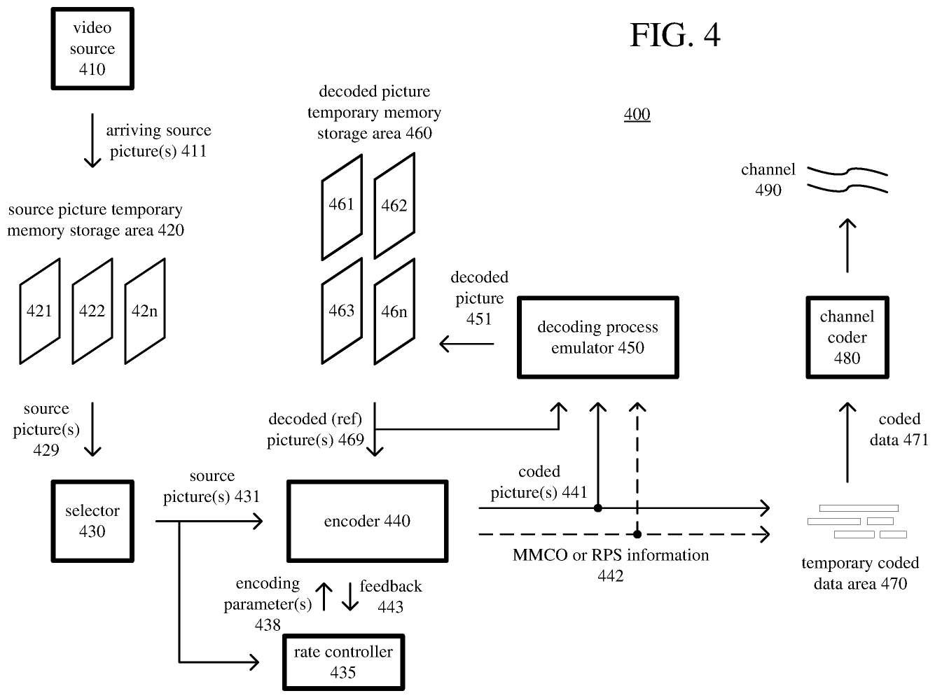

A real-time communication tool (210) is configured to manage encoding by an encoder (220). FIG. 4 shows an example encoder system (400) that can be included in the real-time communication tool (210). Alternatively, the real-time communication tool (210) uses another encoder system. A real-time communication tool (210) is also configured to manage decoding by a decoder (270).

In the network environment (202) shown in FIG. 2b, an encoding tool (212) includes an encoder (220) that is configured to encode media for delivery to multiple playback tools (214), which include decoders (270). The unidirectional communication can be provided for a video surveillance system, web camera monitoring system, remote desktop conferencing presentation or other scenario in which video is encoded and sent from one location to one or more other locations for playback. Although the network environment (202) in FIG. 2b includes two playback tools (214), the network environment (202) can include more or fewer playback tools (214). In general, a playback tool (214) is configured to communicate with the encoding tool (212) to determine a stream of encoded media for the playback tool (214) to receive. The playback tool (214) is configured to receive the stream, buffer the received encoded data for an appropriate period, and begin decoding and playback.

FIG. 4 shows an example encoder system (400) that can be included in the encoding tool (212). Alternatively, the encoding tool (212) uses another encoder system. The encoding tool (212) can also include server-side controller logic for managing connections with one or more playback tools (214). A playback tool (214) can also include client-side controller logic for managing connections with the encoding tool (212).

### III. Example Video Encoder Systems.

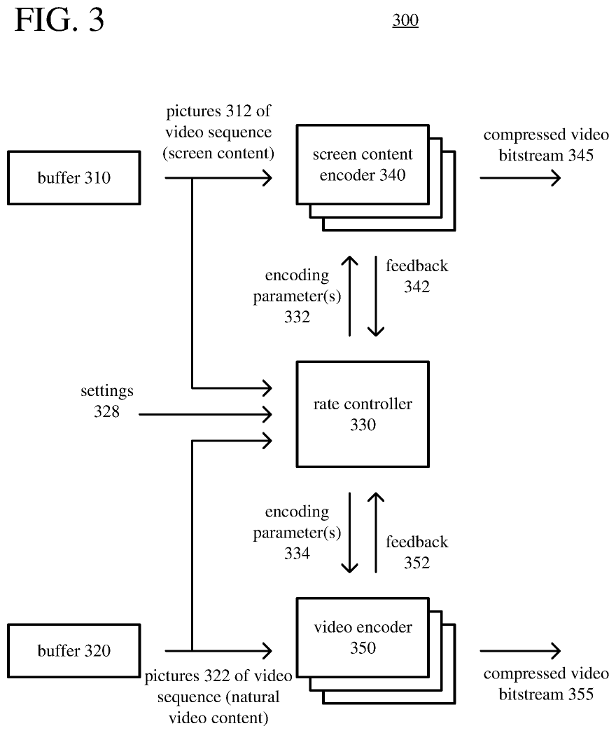

FIG. 3 is a block diagram of an example video encoder system (300), including multiple types of video encoders and a rate controller, in which some described embodiments can be implemented. The video encoder system (300) is a special-purpose encoding tool adapted for low-latency encoding mode for real-time communication. Alternatively, the video encoder system (300) can be a general-purpose encoding tool capable of operating in any of multiple encoding modes such as a low-latency encoding mode for real-time communication, a transcoding mode, and a higher-latency encoding mode for producing media for playback from a file or stream. The video encoder system (300) can be implemented as an operating system module, as part of an application library, or as a standalone application.

The video encoder system (300) includes two buffers (310, 320), a rate controller (330), and multiple types of encoders (340, 350). Alternatively, the video encoder system (300) can include one or more additional types of encoders, each having an associated buffer. FIG. 4 shows a video encoder system (400) from a different perspective, with additional details for some components of the video encoder system (300) shown in FIG. 3.

In FIG. 3, the buffer (310) receives and stores pictures (312) of screen content from a video source such as a screen capture module or operating system. The pictures are part of a series in a video sequence. The buffer (310) provides the pictures (312) to one or more screen content encoders (340). The buffer (310) is an example of the source picture temporary memory storage area (420) shown in FIG. 4.

The buffer (320) receives and stores pictures (322) of natural video content from a video source such as a camera. The pictures are part of a series in a video sequence. The buffer (320) provides the pictures (322) to one or more video encoders (350). The buffer (320) is another example of the source picture temporary memory storage area (420) shown in FIG. 4.

The rate controller (330) receives the pictures (312, 322) from the buffers (310, 320) and also receives feedback (342, 352) from the encoders (340, 350). The rate controller (330) sets encoding parameters (332, 334) for the respective encoders (340, 350). For example, the encoding parameter(s) (332) provided to one of the screen content encoder(s) (340) include a target bit rate, a frame rate for encoding, and/or a spatial resolution for pictures to be encoded by that screen content encoder (340). Similarly, the encoding parameter(s) (334) provided to one of the video encoder(s) (350) include a target bit rate, a frame rate for encoding, and/or a spatial resolution for pictures to be encoded by that video encoder (350). Alternatively, the encoding parameters (332, 334) include other and/or additional parameters. As one of the encoding parameters (332, 334), the rate controller (330) can switch between different ones of the screen content encoders (340) or switch between different ones of the video encoders (350). For example, the video encoder system (300) can include multiple screen content encoders (340), with one of the screen content encoders (340) being used for low-motion video, and a different one of the screen content encoders (340) being used for high-motion video.

The feedback (342) from one of the screen content encoder(s) (340) can include, for example, bit rate of encoded data, quantization parameter (“QP”) values for the encoded data, and values of other parameters for the encoded data. Similarly, the feedback (352) from one of the video encoder(s) (350) can include, for example, bit rate of encoded data, QP values for the encoded data, and values of other parameters for the encoded data. In particular, the rate controller (330) performs operations to allocate bit rate between video streams using machine learning, as described below.

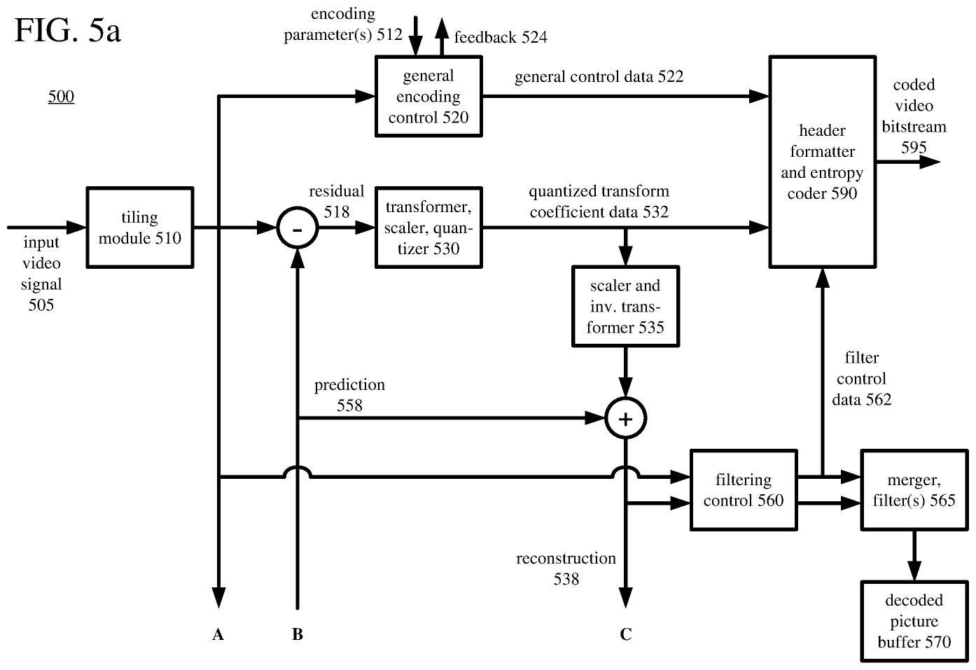

One of the screen content encoder(s) (340) receives the pictures (312) of screen content from the buffer (310) and compresses the pictures (312) to produce a compressed video bitstream (345). The screen content encoder (340) performs compression according to the encoder parameter(s) (332) received from the rate controller (330). The screen content encoder (340) provides feedback (342) on the results of compression to the rate controller (330). The screen content encoder (340) can include components as described with reference to FIGS. 5a and 5b, or it can include other components. For example, the screen content encoder (340) is a variable bit rate encoder that compresses screen content to a target bit rate or lower bit rate. The screen content encoder (340) can be an AV1 encoder, H.264/AVC encoder, or other type of encoder. The screen content encoder (340) can include an internal rate controller, which works in tandem with the rate controller (330) shown in FIG. 3.

One of the video encoder(s) (350) receives the pictures (322) of natural video content from the buffer (320) and compresses the pictures (322) to produce a compressed video bitstream (355). The video encoder (350) performs compression according to the encoder parameter(s) (334) received from the rate controller (330). The video encoder (350) provides feedback (352) on the results of compression to the rate controller (330). The video encoder (350) can include components as described with reference to FIGS. 5a and 5b, or it can include other components. For example, the video encoder (350) is a variable bit rate encoder that compresses camera video content to a target bit rate or lower bit rate. The video encoder (350) can be an AV1 encoder, H.264/AVC encoder, or other type of encoder. The video encoder (350) can include an internal rate controller, which works in tandem with the rate controller (330) shown in FIG. 3.

FIG. 4 is a block diagram of an example video encoder system (400) in conjunction with which some described embodiments may be implemented. The video encoder system (400) can be a general-purpose encoding tool capable of operating in any of multiple encoding modes such as a low-latency encoding mode for real-time communication, a transcoding mode, and a higher-latency encoding mode for producing media for playback from a file or stream, or it can be a special-purpose encoding tool adapted for one such encoding mode. The video encoder system (400) can be adapted for encoding a particular type of content (e.g., screen content, or natural video content). The video encoder system (400) can be implemented as an operating system module, as part of an application library, or as a standalone application. Overall, the video encoder system (400) receives a sequence of source video pictures (411) from a video source (410) and produces encoded data as output to a channel (490). The encoded data output to the channel can include content encoded after bit rate allocation using a machine learning model.

The video source (410) can be a camera, tuner card, storage media, screen capture module, or other digital video source. The video source (410) produces a sequence of video pictures at a frame rate of, for example, 30 frames per second. As used herein, the term “picture” generally refers to source, coded, or reconstructed image data. For progressive-scan video, a picture is a progressive-scan video frame. For interlaced video, an interlaced video frame can be de-interlaced prior to encoding. Alternatively, two complementary interlaced video fields can be encoded together as a single video frame or encoded as two separately encoded fields. Aside from indicating a progressive-scan video frame or interlaced-scan video frame, the term “picture” can indicate a single non-paired video field, a complementary pair of video fields, a video object plane that represents a video object at a given time, or a region of interest in a larger image. The video object plane or region can be part of a larger image that includes multiple objects or regions of a scene.

An arriving source picture (411) is stored in a source picture temporary memory storage area (420) that includes multiple picture buffer storage areas (421, 422, . . . , 42n). A picture buffer (421, 422, etc.) holds one picture in the source picture storage area (420). After one or more of the source pictures (411) have been stored in picture buffers (421, 422, etc.), a picture selector (430) selects an individual source picture from the source picture storage area (420). The order in which pictures are selected by the picture selector (430) for input to the encoder (440) may differ from the order in which the pictures are produced by the video source (410), e.g., the encoding of some pictures may be delayed in order, so as to allow some later pictures to be encoded first and to thus facilitate temporally backward prediction. Before the encoder (440), the video encoder system (400) can include a pre-processor (not shown) that performs pre-processing (e.g., filtering) of the selected picture (431) before encoding. The pre-processing can include color space conversion into primary (e.g., luma) and secondary (e.g., chroma differences toward red and toward blue) components and resampling processing (e.g., to reduce the spatial resolution of chroma components, or for all components) for encoding. Typically, before encoding, video has been converted to a color space such as YUV, in which sample values of a luma (Y) component represent brightness or intensity values, and sample values of chroma (U, V) components represent color-difference values. The precise definitions of the color-difference values (and conversion operations to/from YUV color space to another color space such as RGB) depend on implementation. In general, as used herein, the term YUV indicates any color space with a luma (or luminance) component and one or more chroma (or chrominance) components, including Y′UV, YIQ, Y′IQ and YDbDr as well as variations such as YCbCr and YCoCg. The chroma sample values may be sub-sampled to a lower chroma sampling rate (e.g., for YUV 4:2:0 format), or the chroma sample values may have the same resolution as the luma sample values (e.g., for YUV 4:4:4 format). Or, the video can be encoded in another format (e.g., RGB 4:4:4 format), in which the color components are organized as primary and secondary components. Screen capture content is often encoded in a format (e.g., YUV 4:4:4 or RGB 4:4:4) with high chroma sampling resolution, although it may also be encoded in a format with lower chroma sampling resolution (e.g., YUV 4:2:0).

The rate controller (435) is an example of the rate controller (330) of FIG. 3. The rate controller (435) receives the pictures (431) from the selector (430) (or pre-processor, which is not shown) and also receives feedback (443) from the encoder (440). The rate controller (435) sets one or more encoding parameters (438) for the encoder (440). For example, the encoding parameter(s) (438) include a target bit rate, a frame rate for encoding, and/or a spatial resolution for pictures to be encoded by the encoder (440). Alternatively, the encoding parameter(s) (438) include other and/or additional parameters. As one of the encoding parameter(s) (438), the rate controller (435) can switch between different encoders. The feedback (443) from the encoder (440) can include, for example, bit rate of encoded data, QP values for the encoded data, and values of other parameters for the encoded data. The rate controller (435) can provide feedback to the pre-processor (e.g., a spatial resolution for pictures to be encoded). In particular, the rate controller (435) performs operations to control allocation of bit rate between video streams using machine learning, as described below.

The encoder (440) is an example of a screen content encoder (340) or video encoder (350) shown in FIG. 3. The encoder (440) encodes the selected picture (431) to produce a coded picture (441). FIGS. 5a and 5b are block diagrams of a generalized video encoder (500) in conjunction with which some described embodiments may be implemented. The encoder (500) receives the selected, current picture (431) from a sequence of video pictures as an input video signal (505) and produces encoded data for the coded picture (441) in a coded video bitstream (595) as output. The codec format of the coded video bitstream (595) can be H.264/AVC format, H.265/HEVC format, AV1 format, or another codec format, or a variation or extension thereof.

The encoder (500) compresses pictures using intra-picture coding and inter-picture coding. Many of the components of the encoder (500) are used for both intra-picture coding and inter-picture coding. The exact operations performed by those components can vary depending on the codec format and the type of information being compressed.

A tiling module (510) optionally partitions a picture into multiple tiles of the same size or different sizes. For example, the tiling module (510) splits the picture along tile rows and tile columns that, with picture boundaries, define horizontal and vertical boundaries of tiles within the picture, where each tile is a rectangular region. Tiles are often used to provide options for parallel processing. In implementations for the AV1 format, the encoder (500) can also partition a picture into segments, and parameters of blocks (or superblocks) of a given segment can be collectively signaled for the given segment, which can improve compression efficiency. In implementations for the H.264/AVC format or H.265/HEVC format, the encoder (500) partitions a picture into one or more slices. A slice can be an entire picture or a section of the picture. A slice can be decoded independently of other slices in a picture, which improves error resilience.

The content of a picture (or tile, slice, etc.) is further partitioned into blocks of sample values for purposes of encoding and decoding. The encoder (500) is block-based and uses a block format that depends on implementation. Blocks may be further sub-divided at different stages, e.g., at the prediction, frequency transform and/or entropy encoding stages. For example, a picture can be divided into 256×256 blocks, 128×128 blocks, 64×64 blocks, 32×32 blocks, or 16×16 blocks, which can in turn be divided into smaller blocks of sample values at different stages of coding and decoding.

In implementations of encoding for the AV1 format, for example, the encoder (500) partitions a picture (or tile) into superblocks. A superblock (“SB”) includes luma sample values organized as a luma block and corresponding chroma sample values organized as chroma blocks. A root SB with size 128×128 can be recursively partitioned into smaller square SBs of size 64×64, 32×32, 16×16, or 8×8. A given square 2N×2N SB can also be partitioned into two rectangular N×2N or 2N×N SBs, in which case the smaller N×2N or 2N×N SBs are not further partitioned. Thus, the size of an SB can be 128×128, 128×64, 64×128, 64×64, 64×32, 32×64, 32×32, 32×16, 16×32, 16×16, 16×8, 8×16, or 8×8. Further, an 8×8 SB can be split into two 8×4 SBs, two 4×8 SBs, or four 4×4 SBs for some operations.

Generally, prediction operations are performed for an SB as a prediction unit. An SB may be split into smaller blocks for transform operations, or multiple SBs may be combined for a transform that covers multiple prediction units (SBs). Parameters such as prediction mode (inter or intra), MV data, reference frame data, interpolation filter type, transform size and type, skip status, and segment index are typically specified for an SB. For a small SB (e.g., 8×4 SB, 4×8 SB, or 4×4 SB), however, some parameters (such as prediction mode and MV data) can be signaled for the small SB while other parameters are signaled for the 8×8 SB that includes the small SB.

In implementations of encoding for the H.265/HEVC format, for example, the encoder (500) splits the content of a picture (or slice or tile) into coding tree units. A coding tree unit (“CTU”) includes luma sample values organized as a luma coding tree block (“CTB”) and corresponding chroma sample values organized as two chroma CTBs. The size of a CTU (and its CTBs) is selected by the encoder. A luma CTB can contain, for example, 64×64, 32×32 or 16×16 luma sample values. A CTU includes one or more coding units. A coding unit (“CU”) has a luma coding block (“CB”) and two corresponding chroma CBs. A CTU can be split into four CUs, with each CU possibly being split further into smaller CUs. The smallest allowable size of CU (e.g., 8×8, 16×16) can be signaled in the bitstream.

Generally, a CU has a prediction mode such as inter or intra. A CU includes one or more prediction units for purposes of signaling of prediction information (such as prediction mode details, displacement values, etc.) and/or prediction processing. A prediction unit (“PU”) has a luma prediction block (“PB”) and two chroma PBs. According to the H.265/HEVC format, for an intra-predicted CU, the PU has the same size as the CU, unless the CU has the smallest size (e.g., 8×8). In that case, the CU can be split into smaller PUs (e.g., four 4×4 PUs, two 4×8 PUs, or two 8×4 PUs, if the smallest CU size is 8×8, for intra-picture prediction) or the PU can have the smallest CU size, as indicated by a syntax element for the CU. Alternatively, a larger CU can be split into multiple PUs. A CU also has one or more transform units for purposes of residual coding/decoding, where a transform unit (“TU”) has a luma transform block (“TB”) and two chroma TBs. A PU in an intra-predicted CU may contain a single TU (equal in size to the PU) or multiple TUs. The encoder decides how to partition video into CTUs, CUs, PUs, TUs, etc.

In implementations of encoding for the H.264/AVC format, for example, the encoder (500) splits the content of a picture (or slice) into macroblocks. A macroblock (“MB”) includes luma sample values organized as luma blocks and corresponding chroma sample values organized as chroma blocks. The size of a MB is, for example, 16×16 luma sample values, with corresponding blocks of chroma sample values. Variable-size partitions of a macroblock are encoded using prediction, and 8×8 or 4×4 blocks are used for purposes of residual coding/decoding.

As used herein, the term “block” can indicate an m×n arrangement of sample values, a residual data unit, a CTB, a CB, a PB, a TB, or some other set of sample values, depending on context. A block can be square or rectangular, or even a single column or row of sample values. Alternatively, a block can have some other shape (e.g., triangle, hexagon, arbitrary shape, or an area of a coded video object with a non-rectangular shape). Blocks can have sizes that vary within a picture. Prediction and transform operations can be performed on a block-by-block basis. The term “unit” can indicate an SB, a macroblock, a CTU, a CU, a PU, a TU, or some other set of blocks, or it can indicate a single block, depending on context. Units can have sizes that vary within a picture. A luma block is an example of a primary component block for a YUV color space. The label “luma block” is sometimes used, however, to indicate a primary component block even for another color space such as an RGB color space, BGR color space, or GBR color space. Similarly, a chroma block is an example of a secondary component block for a YUV color space. The label “chroma block” is sometimes used, however, to indicate a secondary component block even for another color space such as an RGB color space, BGR color space, or GBR color space.

With reference to FIG. 5a, the general encoding control (520) receives pictures for the input video signal (505), encoding parameter(s) (512) from a rate controller (such as the rate controller (330, 435) of FIG. 3 or 4), and feedback (not shown) from various modules of the encoder (500). Overall, the general encoding control (520) provides control signals (not shown) to other modules (such as the tiling module (510), transformer/scaler/quantizer (530), scaler/inverse transformer (535), intra-picture estimator (540), intra-picture predictor (545), motion estimator (550), motion compensator (555) and intra/inter switch) to set and change coding parameters during encoding. The general encoding control (520) also provides feedback (524) to the rate controller. The general encoding control (520) can also evaluate intermediate results during encoding, for example, performing rate-distortion analysis. The general encoding control (520) produces general control data (522) that indicates decisions made during encoding, so that a corresponding decoder can make consistent decisions. The general control data (522) is provided to the header formatter/entropy coder (590).

If the current picture is predicted using inter-picture prediction, a motion estimator (550) estimates the motion of blocks of sample values of a current picture of the input video signal (505) with respect to candidate blocks in one or more reference pictures. For example, the motion estimator (550) estimates the motion of a current block in the current picture relative to one or more reference pictures. For motion estimation and compensation, a reference block is a block of sample values in a reference picture that is used to generate prediction values for the current block of sample values of the current picture. The decoded picture buffer (570) buffers one or more reconstructed previously coded pictures for use as reference pictures. When multiple reference pictures are used, the multiple reference pictures can be from different temporal directions or the same temporal direction. The motion estimator (550) produces as side information motion data (552) such as MV data, merge mode index values or other MV selection data, and reference picture selection data. The motion data (552) is provided to the header formatter/entropy coder (590) as well as the motion compensator (555).

The motion compensator (555) applies MVs to the reconstructed reference picture(s) from the decoded picture buffer (570). The motion compensator (555) produces motion-compensated predictions for blocks in the current picture.

In a separate path within the encoder (500), an intra-picture estimator (540) determines how to perform intra-picture prediction for blocks of sample values of a current picture of the input video signal (505) using other, previously reconstructed sample values in the current picture. The current picture can be entirely or partially coded using intra-picture coding. Using sample values of a reconstruction (538) of the current picture, for intra spatial prediction (extrapolation), the intra-picture estimator (540) determines how to spatially predict sample values of a current block in the current picture from neighboring, previously reconstructed sample values of the current picture.

Or, for intra BC prediction, the intra-picture estimator (540) estimates displacement from a current block in the current picture to a position of a candidate block in previously reconstructed sample values of the current picture. For intra BC prediction, a reference block of sample values in the current picture is used to generate prediction values for the current block. For example, for intra BC prediction, the intra-picture estimator (540) estimates displacement from a current block to a reference block, which can be indicated with a BV value.

Depending on implementation, the intra-picture estimator (540) can perform BV estimation for the current block using reconstructed sample values before in-loop filtering, using reconstructed sample values after in-loop filtering, or using input sample values. The intra-picture estimator (540) produces as side information intra prediction data (542), such as information indicating whether intra prediction uses spatial prediction or intra BC prediction, prediction mode direction (for intra spatial prediction), and BV values (for intra BC prediction). The intra prediction data (542) is provided to the header formatter/entropy coder (590) as well as the intra-picture predictor (545).

According to the intra prediction data (542), the intra-picture predictor (545) spatially predicts sample values of a current block in the current picture from neighboring, previously reconstructed sample values of the current picture. Or, for intra BC prediction, the intra-picture predictor (545) predicts the sample values of a current block using previously reconstructed sample values of a reference block, which is indicated by a displacement (BV value) for the current block.

In some example implementations, intra BC prediction is a special case of motion compensation for which the reference picture is the current picture. In such implementations, functionality described above with reference to the intra-picture estimator (540) and intra-picture predictor (545) for BV estimation and intra BC prediction can be implemented in the motion estimator (550) and motion compensator (555), respectively.

For motion compensation and intra BC prediction, an encoder typically finds a single MV or BV value for a prediction unit, and that single MV or BV value (or a scaled version thereof) is used for the blocks of the prediction unit. When the chroma data for a picture has the same resolution as the luma data (e.g. when the format is YUV 4:4:4 format or RGB 4:4:4 format), the MV or BV value that is applied for the chroma block may be the same as the MV or BV value applied for the luma block. On the other hand, when the chroma data for a picture has reduced resolution relative to the luma data (e.g. when the format is YUV 4:2:0 format), the MV or BV value that is applied for the chroma block may be scaled down and possibly rounded to adjust for the difference in chroma resolution (e.g. by dividing the vertical and horizontal components of the BV value by two and truncating or rounding them to integer values).

For a palette coding mode, the encoder (500) represents at least some of the sample values of a unit using a palette. The palette represents colors used in the unit. For example, the palette maps index values 0, 1, 2, . . . , p to corresponding colors, which can be in RGB 4:4:4 format, BGR 4:4:4 format, GBR 4:4:4 format, YUV 4:4:4 format, or another format (color space, color sampling rate). An index value can represent a RGB triplet, BGR triplet or GBR triplet for a pixel, where a pixel is a set of co-located sample values. For encoding of the unit, appropriate index values replace the sample values of pixels in the unit. A rare value in the unit can be encoded using an escape code value and literal values, instead of using an index value in the palette. The palette can change from unit to unit, and palette data specifying the palettes can be signaled in the bitstream.

The intra/inter switch selects whether the prediction (558) for a given block will be a motion-compensated prediction or intra-picture prediction.

In some example implementations, no residual is calculated for a unit encoded in palette coding mode. Instead, residual coding is skipped, and the predicted sample values are used as the reconstructed sample values. Residual coding can selectively be skipped for other blocks.

When residual coding is not skipped, the difference (if any) between a block of the prediction (558) and a corresponding part of the original current picture of the input video signal (505) provides values of the residual (518). During reconstruction of the current picture, when residual values have been encoded/signaled, reconstructed residual values are combined with the prediction (558) to produce an approximate or exact reconstruction (538) of the original content from the video signal (505). (In lossy compression, some information is lost from the video signal (505).)

As part of residual coding, in the transformer/scaler/quantizer (530), when a frequency transform is not skipped, a frequency transformer converts spatial-domain video information into frequency-domain (i.e., spectral, transform) data. For block-based video coding, the frequency transformer applies a discrete cosine transform (“DCT”), an integer approximation thereof, or another type of forward block transform (e.g., a discrete sine transform or an integer approximation thereof) to blocks of prediction residual data (or sample value data if the prediction (558) is null), producing blocks of frequency transform coefficients. The transformer/scaler/quantizer (530) can apply a transform with variable block sizes. In this case, the transformer/scaler/quantizer (530) can determine which block sizes of transforms to use for the residual values for a current block. The scaler/quantizer scales and quantizes the transform coefficients. The encoder (500) can set values for QP for a picture, tile, slice and/or other portion of video, and quantize transform coefficients accordingly. For example, the quantizer applies dead-zone scalar quantization to the frequency-domain data with a quantization step size that varies on a picture-by-picture basis, tile-by-tile basis, slice-by-slice basis, block-by-block basis, frequency-specific basis, or other basis. The quantized transform coefficient data (532) is provided to the header formatter/entropy coder (590). If the frequency transform is skipped, the scaler/quantizer can scale and quantize the blocks of prediction residual data (or sample value data if the prediction (558) is null), producing quantized values that are provided to the header formatter/entropy coder (590).

To reconstruct residual values, in the scaler/inverse transformer (535), a scaler/inverse quantizer performs inverse scaling and inverse quantization on the quantized transform coefficients. When the transform stage has not been skipped, an inverse frequency transformer performs an inverse frequency transform, producing blocks of reconstructed prediction residual values or sample values. If the transform stage has been skipped, the inverse frequency transform is also skipped. In this case, the scaler/inverse quantizer can perform inverse scaling and inverse quantization on blocks of prediction residual data (or sample value data), producing reconstructed values. When residual values have been encoded/signaled, the encoder (500) combines reconstructed residual values with values of the prediction (558) (e.g., motion-compensated prediction values, intra-picture prediction values) to form the reconstruction (538). When residual values have not been encoded/signaled, the encoder (500) uses the values of the prediction (558) as the reconstruction (538).

For intra-picture prediction, the values of the reconstruction (538) can be fed back to the intra-picture estimator (540) and intra-picture predictor (545). The values of the reconstruction (538) can be used for motion-compensated prediction of subsequent pictures.

The values of the reconstruction (538) can be further filtered. A filtering control (560) determines how to perform adaptive deblock filtering, sample adaptive offset (“SAO”) filtering, and/or other filtering on values of the reconstruction (538), for a given picture of the video signal (505), within the motion compensation loop (that is, “in-loop” filtering). The filtering control (560) produces filter control data (562), which is provided to the header formatter/entropy coder (590) and merger/filter(s) (565).

In the merger/filter(s) (565), the encoder (500) merges content from different units (and tiles) into a reconstructed version of the picture. The encoder (500) selectively performs deblock filtering, SAO filtering, and/or other filtering (such as constrained directional enhancement filtering or loop restoration filtering) according to the filter control data (562) and rules for filter adaptation, so as to adaptively smooth discontinuities across boundaries in the pictures. Filtering such as de-ringing filtering or adaptive loop filtering (not shown) can alternatively or additionally be applied. Tile boundaries can be selectively filtered or not filtered at all, depending on settings of the encoder (500), and the encoder (500) may provide syntax elements within the coded bitstream to indicate whether or not such filtering was applied. The decoded picture buffer (570) buffers the reconstructed current picture for use in subsequent motion-compensated prediction.

The header formatter/entropy coder (590) formats and/or entropy codes the general control data (522) (e.g., mode decisions), quantized transform coefficient data (532), intra prediction data (542) (e.g., BV values), motion data (552), and filter control data (562). For the motion data (552), the header formatter/entropy coder (590) can select and entropy code merge mode index values, or a default MV predictor can be used. In some cases, the header formatter/entropy coder (590) also determines MV differentials for MV values (relative to MV predictors for the MV values), then entropy codes the MV differentials. For the intra prediction data (542), a BV value can be encoded using prediction. The prediction can use a default predictor (e.g., a BV value from a neighboring unit, or median of BV values from multiple neighboring units). When multiple predictors are possible, a predictor index can indicate which of the multiple predictors to use for prediction of the BV value. The header formatter/entropy coder (590) can select and entropy code predictor index values (for intra BC prediction), or a default predictor can be used. In some cases, the header formatter/entropy coder (590) also determines differentials (relative to predictors for the BV values), then entropy codes the BV differentials. For palette coding mode, the header formatter/entropy coder (590) can encode palette data.

The header formatter/entropy coder (590) can perform entropy coding in various ways. Typical entropy coding techniques include Exponential-Golomb coding, Golomb-Rice coding, context-adaptive binary arithmetic coding (“CABAC”), differential coding, Huffman coding, run length coding, variable-length-to-variable-length (“V2V”) coding, variable-length-to-fixed-length (“V2F”) coding, Lempel-Ziv (“LZ”) coding, dictionary coding, probability interval partitioning entropy coding (“PIPE”), and combinations of the above. The header formatter/entropy coder (590) can use different coding techniques for different kinds of data, can apply multiple techniques in combination (e.g., by applying Golomb-Rice coding followed by CABAC), and can choose from among multiple code tables or contexts within a particular coding technique.

The header formatter/entropy coder (590) provides the encoded data in the coded video bitstream (595). The codec format of the coded video bitstream (595) can be H.264/AVC format, H.265/HEVC format, AV1 format, or another codec format, or a variation or extension thereof.

Depending on implementation and the type of compression desired, modules of an encoder (500) can be added, omitted, split into multiple modules, combined with other modules, and/or replaced with like modules. In alternative embodiments, encoders with different modules and/or other configurations of modules perform one or more of the described techniques. Specific embodiments of encoders typically use a variation or supplemented version of the encoder (500). The relationships shown between modules within the encoder (500) indicate general flows of information in the encoder; other relationships are not shown for the sake of simplicity.

With reference to FIG. 4, in addition to producing encoded data for a coded picture (441), the encoder (440) produces memory management control operation (“MMCO”) signals (442) or reference picture set (“RPS”) information. The RPS is the set of pictures that may be used for reference in motion compensation for a current picture or any subsequent picture. If the current picture is not the first picture that has been encoded, when performing its encoding process, the encoder (440) may use one or more previously encoded/decoded pictures (469) that have been stored in a decoded picture temporary memory storage area (460), which is an example of decoded picture buffer (470). Such stored decoded pictures (469) are used as reference pictures for inter-picture prediction of the content of the current source picture (431). The MMCO/RPS information (442) indicates to a decoder which reconstructed pictures may be used as reference pictures, and hence should be stored in a picture storage area.

The coded pictures (441) and MMCO/RPS information (442) (or information equivalent to the MMCO/RPS information (442), since the dependencies and ordering structures for pictures are already known at the encoder (440)) are processed by a decoding process emulator (450) in the encoder system (400) of FIG. 4. The decoding process emulator (450) implements some of the functionality of a decoder, for example, decoding tasks to reconstruct sample values of the current picture and reference pictures. (In practice, the decoding process emulator (450) is implemented as part of the encoder (440). For example, the decoding process emulator (450) includes the scaler and inverse transformer (435), the merger/filters (465) and other functionality to reconstruct sample values.) In a manner consistent with the MMCO/RPS information (442), the decoding processes emulator (450) determines whether a given coded picture (441) needs to be reconstructed and stored for use as a reference picture in inter-picture prediction of subsequent pictures to be encoded. If a coded picture (441) needs to be stored, the decoding process emulator (450) models the decoding process that would be conducted by a decoder that receives the coded picture (441) and produces a corresponding decoded picture (451). In doing so, when the encoder (440) has used decoded picture(s) (469) that have been stored in the decoded picture storage area (460), the decoding process emulator (450) also uses the decoded picture(s) (469) from the storage area (460) as part of the decoding process.

The decoded picture temporary memory storage area (460) includes multiple picture buffer storage areas (461, 462, . . . , 46n). In a manner consistent with the MMCO/RPS information (442), the decoding process emulator (450) manages the contents of the storage area (460) in order to identify any picture buffers (461, 462, etc.) with pictures that are no longer needed by the encoder (440) for use as reference pictures. After modeling the decoding process, the decoding process emulator (450) stores a newly decoded picture (451) in a picture buffer (461, 462, etc.) that has been identified in this manner.

The coded pictures (441) and MMCO/RPS information (442) are buffered in a temporary coded data area (470). The coded data that is aggregated in the coded data area (470) contains, as part of the syntax of an elementary coded video bitstream, encoded data for one or more pictures represented with syntax elements for various layers of bitstream syntax. The coded data that is aggregated in the coded data area (470) can also include media metadata relating to the coded video data (e.g., as one or more parameters in one or more supplemental enhancement information (“SEI”) messages or video usability information (“VUI”) messages).

The aggregated data (471) from the temporary coded data area (470) is processed by a channel encoder (480). The channel encoder (480) can packetize and/or multiplex the aggregated data for transmission or storage as a media stream (e.g., according to a media program stream or transport stream format), in which case the channel encoder (480) can add syntax elements as part of the syntax of the media transmission stream. Or, the channel encoder (480) can organize the aggregated data for storage as a file (e.g., according to a media container format), in which case the channel encoder (480) can add syntax elements as part of the syntax of the media storage file. Or, more generally, the channel encoder (480) can implement one or more media system multiplexing protocols or transport protocols, in which case the channel encoder (480) can add syntax elements as part of the syntax of the protocol(s). The channel encoder (480) provides output to a channel (490), which represents storage, a communications connection, or another channel for the output. The channel encoder (480) or channel (490) may also include other elements (not shown), e.g., for forward-error correction (“FEC”) encoding and analog signal modulation.

### IV. Examples of Allocating Bit Rate Between Video Streams Using a Machine Learning Model.

In desktop conferencing, video collaboration meetings, and other scenarios, a stream of screen content and one or more streams of camera video content may be compressed and transmitted from one site. The streams may share available network bandwidth, which can vary over time. Network bandwidth may be insufficient for all of the streams to consistently have high quality. When that happens, the quality of the screen content stream is usually prioritized over the quality of the camera video stream(s). In some prior approaches, a fixed amount of bit rate is reserved for the screen content stream, large enough to allow high quality reconstruction for the screen content stream. This can result in sub-optimal quality in the camera video stream(s) when bandwidth constraints are encountered, even when the screen content stream does not currently use all of the bit rate reserved to it. For example, the bit rate used to compress the screen content stream may drop significantly when the screen content stream has low complexity, which is common during static periods of the screen content. It can be difficult to predict the bit rate needs of the screen content stream, however. Therefore, in such prior approaches, bit rate dedicated to the screen content stream is not reallocated to the camera video stream, due the risk of the (prioritized) screen content stream suddenly needing the bit rate originally dedicated to it.

This section presents various features of dynamic allocation of bit rate between video streams using machine learning. For example, a video encoder system receives first feedback values and second feedback values. The first feedback values indicate results of encoding part of a first video sequence. The second feedback values indicate results of encoding part of a second video sequence. A machine learning model accepts the first and second feedback values as inputs. The machine learning model produces a reallocation parameter as output. The video encoder system determines a first target bit rate and a second target bit rate using the reallocation parameter. Then, a first video encoder encodes one or more pictures of the first video sequence at the first target bit rate, and a second video encoder encodes one or more pictures of the second video sequence at the second target bit rate. In this way, in many cases, the video encoder system can effectively and dynamically reallocate unused bit rate from the first video encoder to the second video encoder, then return the bit rate to the first video encoder when needed.

In particular, in some example implementations, a video encoder system uses a machine learning model to predict, in real time, the bit rate health of a screen content stream. The machine learning model monitors statistics and rate control information from the screen content encoder, such as frame drops, average QP used during encoding, allocated bit rate, and bit rate of encoded data from the screen content encoder. Using such information, the video encoder system can predict whether bit rate can be borrowed from the screen content encoder without hurting quality of the screen content stream. Using similar information from a camera video encoder, the video encoder system can predict whether the camera video encoder needs additional bit rate. With such feedback, the video encoder system can detect when a screen content encoder is not using all of the bit rate allocated to it and can reallocate unused bit rate to a camera video encoder. In this way, the video encoder system can dynamically borrow bit rate from the screen content stream when the bit rate is not needed for the screen content stream, to improve the quality of a camera video stream, and hence improve overall quality. When the machine learning model detects that the screen content encoder can use the bit rate again, the video encoder system can allocate the bit rate back to screen content encoder, to mitigate any degradation of quality in the screen content stream.

A. Examples of Machine Learning Models.

This section describes examples of machine learning models for determining a parameter to allocate bit rate between multiple video streams. A video encoder system as described with reference to FIGS. 3 and 4 can use one of the machine learning models.

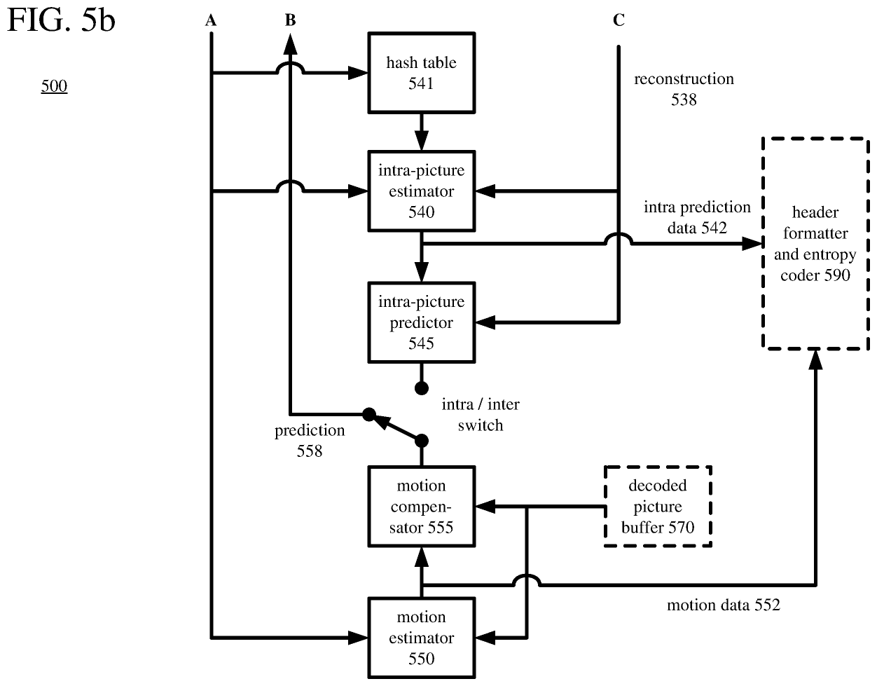

FIG. 6 shows a generalized machine learning model (600) configured to determine a parameter for allocating bit rate between video streams. Specifically, the machine learning model (600) is a neural network that includes an input layer (610), one or more hidden layers (620), and an output layer (630).

The input layer (610) accepts various inputs to the neural network. In FIG. 6, the inputs include one or more feedback values (602) from a first video encoder, one or more feedback values (604) from a second video encoder, and one or more other input(s) (606). The inputs can be provided to the input layer (610) on a picture-by-picture basis or on some other basis (e.g., the last m pictures, where m is 2, 3, or another number of pictures). In some example implementations, the first video encoder is a screen content encoder, and the feedback value(s) (602) from the screen content encoder include a measure of the bit rate of encoded data from the screen content encoder (such as ratio of the bit rate of the encoded data from the screen content encoder to the overall bit rate), a measure of quantization (such as an average QP used in compression by the screen content encoder), a measure of dropped pictures for the screen content encoder (such as a ratio of dropped pictures in a temporal window to all pictures in the temporal window for the screen content encoder), and a measure of the fullness of an output buffer for the screen content encoder. Similarly, in some example implementations, the feedback value(s) (604) from the second video encoder, which is a camera video encoder, include a measure of the bit rate of encoded data from the camera video encoder (such as ratio of the bit rate of the encoded data from the camera video encoder to the overall bit rate), a measure of quantization (such as an average QP used in compression by the camera video encoder), a measure of dropped pictures for the camera video encoder (such as a ratio of dropped pictures in a temporal window to all pictures in the temporal window for the camera video encoder), and a measure of the fullness of an output buffer for the camera video encoder. The other input(s) (606) include, for example, a measure of the total target bit rate for the first and second video encoders. Alternatively, the inputs (602, 604, 606) include other and/or additional types of data.

The input layer (610) includes n neurons connected to the respective p inputs. The value of n depends on implementation. For example, n is 32. Other possible values of n are, for example, 64 and 16. In general, increasing the value of n increases the size and complexity of the neural network. This can improve the effectiveness of the model, but may require more training and may result in overfitting of the model to training data. On the other hand, decreasing the value of n decreases the size and complexity of the neural network. This can simplify training but may limit the effectiveness of the model. The input layer (610) implements a p×n mapping. For example, if there are 9 inputs and 32 neurons in the input layer (610), the input layer (610) implements a 9×32 mapping. The input layer (610) can be a fully connected layer, for which each input is connected to each of the n neurons. Or, the input layer (610) can have fewer connections to simplify the model.

The input layer (610) uses an activation function such as a rectified linear unit (“ReLU”) activation function, leaky ReLU activation function, or other activation function. In general, the activation function is an n×n decision, converting output signals from n neurons in one layer to be taken as inputs to n neurons in the next layer, which helps the neural network learn and recognize complex patterns in data. During training, the activation function changes how weights of neurons are captured. For example, the ReLU activation function is f(x)=max(0, x). As another example, the leaky ReLU activation function can be defined as f(x)=max(0.01×x, x).

Each of the hidden layer(s) (620) includes a layer of neurons and uses an activation function. For example, the layer of neurons is a fully connected layer with n neurons, or a layer with fewer connections. The number of neurons can be the same or different in different layers. The activation function can be, for example, a ReLU activation function, leaky ReLU activation function, or other activation function. In general, the hidden layer(s) (620) are trained to recognize patterns as different non-linear combinations of inputs from the input layer (610).

The output layer (630) produces as output a reallocation parameter (635). The output layer (630) can produce the reallocation parameter (635) on a picture-by-picture basis or on some other basis. The output layer (630) includes a layer of neurons and uses an activation function. For example, the layer of neurons is a fully connected layer with n neurons, or a layer with fewer connections. The activation function is, for example, a sigmoid function that accepts a real number and produces an output in the range of 0.0 to 1.0. For example, the sigmoid function is s(x)=1/(1+e^{-x}). In some example implementations, the output of the output layer (630) is a parameter shift_ratio, which defines a percentage of the bit rate of the first video encoder to shift to the second video encoder. For example, the shift_ratio parameter defines a percentage of bit rate to shift from encoding of screen content to encoding of camera video content. Given the sigmoid function, the range of shift_ratio is 0.0<shift_ratio<1.0. When shift_ratio is 0.0, the target bit rate for the first video encoder will be the full (default) bit rate for the first video encoder. As shift_ratio increases, more bit rate is reallocated from the first video encoder to the second video encoder.

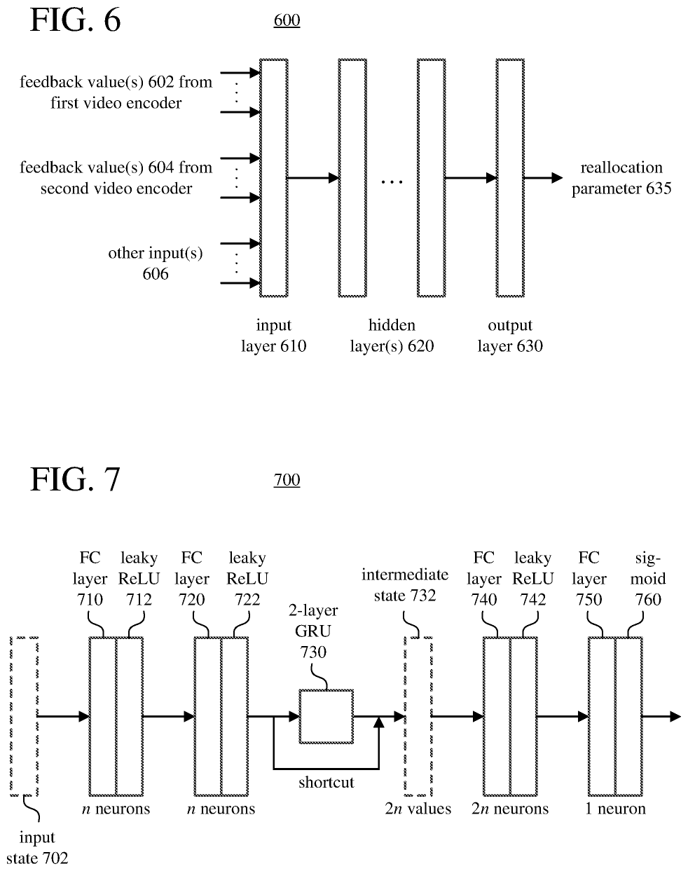

FIG. 7 shows an example machine learning model (700) configured to determine a parameter for allocating bit rate between video streams. The machine learning model (700) is a neural network that includes an input layer implemented with a fully connected layer (710) and uses a leaky ReLU activation function (712). The fully connected layer (710) accepts inputs such as the inputs described with reference to FIG. 6. The inputs are shown in FIG. 7 as the input state (702). The fully connected layer (710) includes n neurons. For example, n is 32. Alternatively, the fully connected layer (710) has another number of neurons.

The machine learning model (700) includes multiple hidden layers. A first hidden layer includes a fully connected layer (720) and uses a leaky ReLU activation function (722). The fully connected layer (720) accepts inputs from the input layer and includes n neurons. For example, n is 32. Alternatively, the fully connected layer (720) has another number of neurons.

The machine learning model (700) also includes a two-layer gated recurrent unit (“GRU”) (730). The GRU (730) has a gating mechanism that delays n outputs from the first hidden layer. A shortcut around the GRU (730) directly sends the n outputs of the first hidden layer (in front of the GRU (730)) to the opposite side of the GRU (730). The n outputs from the first hidden layer and the delayed n outputs from the GRU (730) are concatenated, together providing 2n inputs to a second hidden layer. FIG. 7 shows the concatenated values as an intermediate state (732).

The second hidden layer includes a fully connected layer (740) and uses a leaky ReLU activation function (742). The fully connected layer (740) accepts inputs from the intermediate state (732) and includes 2n neurons. For example, n is 32. Alternatively, the fully connected layer (740) has another number of neurons.

Finally, an output layer includes a fully connected layer (750) and uses a signmoid function (750). The fully connected layer (750) accepts inputs from the second hidden layer and includes 2n neurons. For example, n is 32. Alternatively, the fully connected layer (750) has another number of neurons. The output later produces a reallocation parameter as output, for example, as described with reference to FIG. 6.

B. Examples of Determination of Target Bit Rates.

This section describes examples of operations to determine target bit rates using a reallocation parameter determined using a machine learning model. A video encoder system as described with reference to FIGS. 3 and 4 can perform the operations.

In general, the video encoder system “borrows” bit rate from a first video encoder and reallocates that borrowed bit rate to a second video encoder. For example, the video encoder system determines an amount rate_reallocation, reduces the default bit rate of the first video encoder (default_first_bit_s) to determine a first target bit rate (new_bit_rate_s), and increases the default bit rate of the second video encoder (default_second_bit_v) to determine a second target bit rate (new_bit_rate_v).
new_bit_rate_s=default_bit_rate_s−rate_reallocation
new_bit_rate_v=default_bit_rate_v+rate_reallocation

Alternatively, using a shift_ratio, the video encoder system reduces the default bit rate of the first video encoder (default_first_bit_s) in proportion to the shift_ratio to determine a first target bit rate (new_bit_rate_s). The video encoder system increases the default bit rate of the second video encoder (default_second_bit_v) by a corresponding amount to determine a second target bit rate (new_bit_rate_v).
new_bit_rate_s=default_bit_rate_s×(1−shift_ratio)
new_bit_rate_v=default_bit_rate_v+default_bit_rate_s×shift_ratio

Alternatively, the video encoder system determines the first and second target bit rates in some other way.

The video encoder system can determine the reallocation parameter then update the first and second target bit rates on a picture-by-picture basis. In some example implementations, however, to make the target bit rates more stable, the video encoder system keeps the previous (last used) value of the reallocation parameter unless the new value of the reallocation parameter is significantly different than the previous value of the reallocation parameter. More specifically, the video encoder system keeps the previous value of the reallocation parameter unless the new value of the reallocation parameter satisfies a threshold test for triggering reallocation of the target bit rates. The threshold test can be a range around the previous value of the reallocation parameter. For example, the video encoder system checks whether a new value of the shift ratio (new_shift_ratio) is in a range defined around a previous (last used) value of the shift ratio (previous_shift_ratio). The range can be denoted: (previous_shift_ratio−a, previous_shift_ratio+b). If the new value of the shift ratio is in the range, the video encoder system keeps the previous value of the shift ratio. Otherwise, the video encoder uses the new value of the shift ratio. The values of a and b depend on implementation. For example, a is 0.05 and b is 0.1. This makes it more likely for bit rate to be “reclaimed” by the screen content encoder, even for a small change in shift_ratio. Thus, for a small change in shift_ratio, no change is made to the target bit rates. Alternatively, a and b have other values.

A video encoder system can change the target bit rates for different video encoders on a picture-by-picture basis or less frequently. Reconfiguring a video encoder to operate at a different target bit rate takes time. As such, changing the target bit rate too frequently for a video encoder may be inefficient. In some example implementations, the output of the machine learning model and/or the target bit rates are throttled. The window for throttling the reaction has a duration that depends on implementation. For example, the duration is from 0.5 seconds to 10 seconds. The duration of the window can be the same whether allocating bit rate away from a first video encoder or allocating bit rate back to the first video encoder, or the duration of the window can be different depending on whether the video encoder system is allocating bit rate away from a first video encoder or allocating bit rate back to the first video encoder. In some example implementations, the window for throttling the reaction to determine new target bit rates is 5-10 seconds when allocating bit rate from a screen content encoder to a camera video encoder, but the window for throttling the reaction to determine new target bit rates is shorter when allocating bit rate from the camera video encoder back to the screen content encoder. Alternatively, the usual window for throttling the reaction is the same whether allocating bit rate to or from the screen content encoder, but target bit rates are adjusted more quickly if the reallocation parameter changes dramatically. For example, if the value of shift_ratio drops by more than a threshold amount (indicating that bit rate should be reclaimed by the screen content encoder), the video encoder system more promptly changes the target bit rates.

C. Example Techniques for Allocating Bit Rate Between Video Streams Using a Machine Learning Model.

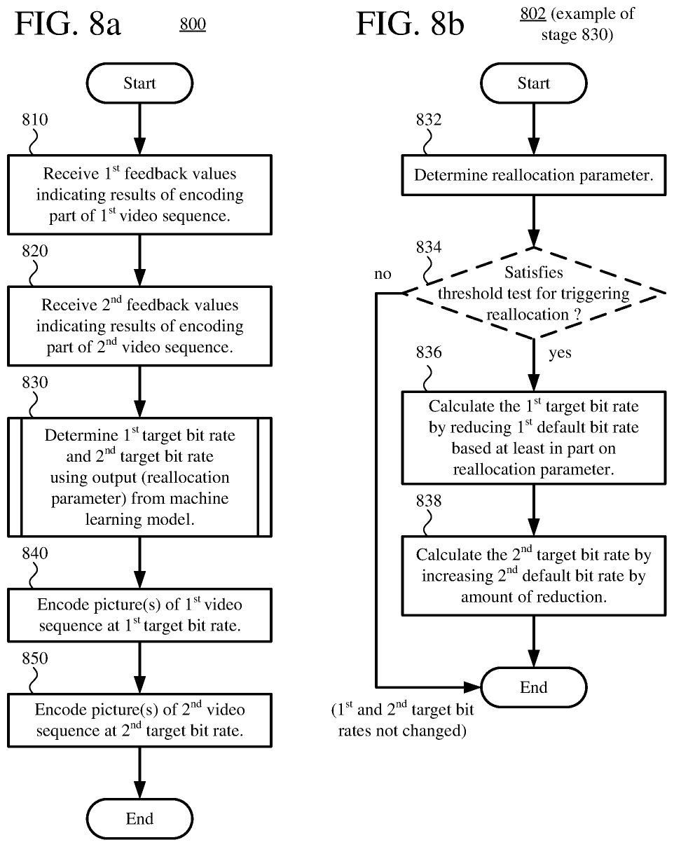

FIG. 8a shows a generalized technique (800) for allocating bit rate between video streams using a machine learning model. A video encoder system such as one described with reference to FIGS. 3 and 4, or another video encoder system, can perform the technique (800). The technique (800) can be performed as part of a real-time encoding scenario or other encoding scenario, to allocate bit rate between a screen content stream and camera video stream, or to allocate bit rate between other types of video streams, using a machine learning model.

FIG. 8a shows certain operations performed when encoding one or more pictures. The video encoder system can repeat the technique (800) to encode other pictures of a sequence.

To start, the video encoder system receives (810) first feedback values indicating results of encoding part of a first video sequence with a first video encoder. The part of the first video sequence for which feedback values are received can be the previous picture in coding order for the first video sequence, the last x pictures in coding order (where x is 2, 3, or some other number of pictures) for the first video sequence, or some other amount of just-compressed video for the first video sequence. The video encoder system also receives (820) second feedback values indicating results of encoding part of a second video sequence with a second video encoder. The part of the second video sequence for which feedback values are received can be the previous picture in coding order for the second video sequence, the last x pictures in coding order (where x is 2, 3, or some other number of pictures) for the second video sequence, or some other amount of just-compressed video for the second video sequence. For example, a rate controller of the video encoder system is configured to receive (810, 820) the first and second feedback values. In some example scenarios, the first video sequence includes pictures of screen content, and the second video sequence includes pictures of camera video content.

The type of data in the first and second feedback values depends on implementation. The first feedback values can include (a) a measure of encoded bit rate for the part of the first video sequence (e.g., a count of bits of encoded data for the part of the first video sequence, or a ratio of bits of encoded data for the part of the first video sequence compared to overall bit rate), (b) a measure of quantization for the part of the first video sequence (e.g., an average QP used for the part of the first video sequence), (c) a measure of dropped pictures for the first video sequence (e.g., a count of dropped pictures of the first video sequence in a history window, or a ratio of dropped pictures of the first video sequence to all pictures of the first video sequence in the history window), and/or (d) a measure of buffer fullness for the first video sequence (e.g., a ratio of number of bits of encoded data for the first video sequence in an output buffer to the size of the output buffer). Alternatively, the first feedback values include other and/or additional types of data. The second feedback values can include (a) a measure of encoded bit rate for the part of the second video sequence (e.g., a count of bits of encoded data for the part of the second video sequence, or a ratio of bits of encoded data for the part of the second video sequence compared to overall bit rate), (b) a measure of quantization for the part of the second video sequence (e.g., an average QP used for the part of the second video sequence), (c) a measure of dropped pictures for the second video sequence (e.g., a count of dropped pictures of the second video sequence in a history window, or a ratio of dropped pictures of the second video sequence to all pictures of the second video sequence in the history window), and/or (d) a measure of buffer fullness for the second video sequence (e.g., a ratio of number of bits of encoded data for the second video sequence in an output buffer to the size of the output buffer). Alternatively, the second feedback values include other and/or additional types of data.

The video encoder system determines (830) a first target bit rate and a second target bit rate using an output from a machine learning model. For example, the rate controller of the video encoder system is configured to determine (830) the first and second target bit rates.

In general, the machine learning model accepts, as inputs, the first feedback values and the second feedback values. The machine learning model can also accept, as one of its inputs, a measure of total target bit rate for the first video sequence and the second video sequence. Alternatively, the machine learning model accepts other and/or additional types of data as inputs. The machine learning model produces, as the output, a reallocation parameter. For example, the reallocation parameter is a shift ratio that indicates bit rate to reallocate from the encoding of the first video sequence to the encoding of the second video sequence. Alternatively, the machine learning model produces another type of data as output.

FIG. 8b shows an example approach (802) to determining (830) the first and second target bit rates using the output of a machine learning model. The video encoder system determines (832) the reallocation parameter as the output from the machine learning model. For example, the video encoder system determines the reallocation parameter as a value of shift ratio between 0.0 and 1.0.

The video encoder system optionally checks (834) whether the reallocation parameter satisfies a threshold test for triggering reallocation of bit rate from the encoding of the first video sequence to the encoding of the second video sequence. For example, the video encoder system checks whether the new value of the reallocation parameter is outside a threshold range around the previous (last used) value of the reallocation parameter. The threshold range depends on implementation and can have the same offset, or different offsets, on the respective sides of the previous value of the reallocation parameter. If the reallocation parameter does not satisfy the threshold test, the first and second target bit rates are not changed. Otherwise (the reallocation parameter satisfies the threshold test), the first and second target bit rates are changed.

In FIG. 8b, after determining the reallocation parameter, the video encoder system calculates (836) the first target bit rate by reducing a first default bit rate based at least in part on the reallocation parameter. The video encoder system also calculates (838) the second target bit rate by increasing a second default bit rate based at least in part on the reallocation parameter (e.g., by an amount corresponding to the reduction of the first default bit rate). For example, the video encoder system calculates the first target bit rate by multiplying the first default bit rate by a reduction factor, where the reduction factor is 1 minus the shift ratio. The video encoder system can calculate the second target bit rate by adding, to the second default bit rate, the result of multiplying the first default bit rate by the shift ratio. Alternatively, the video encoder system calculates the first and second target bit rates in some other way using the reallocation parameter (e.g., determining an amount that is subtracted from the first default bit rate and added to the second default bit rate).

In some example implementations, the machine learning model uses a neural network that includes an input layer (which accepts the inputs), one or more hidden layers, and an output layer (which produces the output, e.g., reallocation parameter). Examples of neural networks are described with reference to FIGS. 6 and 7.

In general, the input layer and each of the one or more hidden layers of the neural network can include a fully connected layer and use an activation function, which can be a ReLU activation function, leaky ReLU activation function, or other function. A fully connected layer has a number of neurons (such as 16, 32, or 64) that depends on implementation. Alternatively, the input layer and/or at least one of the hidden layers can have fewer connections than a fully connected layer, to simplify the model. The neural network can also include a gated recurrent unit, which has a gating mechanism that delays n outputs from a given hidden layer among the one or more hidden layers. The n outputs from the given hidden layer and the delayed n outputs can be concatenated, together providing 2n inputs to a next hidden layer among the one or more hidden layers. The output layer of the neural network can include another fully connected layer or have fewer connections than a fully connected layer. The output layer can also include a sigmoid function, which produces the reallocation parameter in a range between 0 and 1.

Returning to FIG. 8a, after the first and second target bit rates have been determined, the video encoder system encodes (840) one or more pictures of the first video sequence at the first target bit rate. For example, a first video encoder is configured to encode the picture(s) of the first video sequence at the first target bit rate. The first video encoder can be adapted for encoding of screen content or other content, depending on implementation. The video encoder system also encodes (850) one or more pictures of the second video sequence at the second target bit rate. For example, a second video encoder is configured to encode the picture(s) of the second video sequence at the second target bit rate. The second video encoder can be adapted for encoding of camera video content or other content, depending on implementation.

D. Examples of Training Processes for Machine Learning Models.

This section describes examples of training processes for machine learning models used to determine a parameter to allocate bit rate between multiple streams. In some example implementations, the training processes use actor-critic reinforcement learning to train the machine learning model. A video encoder system as described with reference to FIGS. 3 and 4 can perform the training processes.

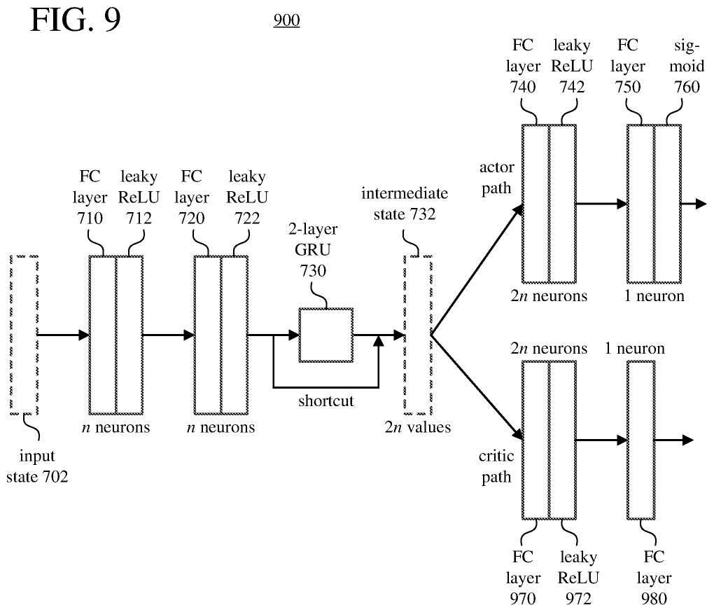

FIG. 9 shows an example machine learning model (900) configured for training, with actor-critic reinforcement learning, to determine a parameter for allocating bit rate between video streams. The machine learning model (900) is a neural network that includes the inputs, layers, and activation functions of the machine learning model (700) shown in FIG. 7. In particular, the machine learning model (900) of FIG. 9 includes inputs in an input state (702), fully connected layers (710, 720, 740, 750), activation functions (712, 722, 742, 760), a GRU (730), and an intermediate state (732) of the machine learning model (700) of FIG. 7, which generally operate as described above.

In FIG. 9, the second hidden layer and output layer—including the fully connected layer (740) with 2n neurons, leaky ReLU activation function (742), following fully connected layer (750), and sigmoid function (760)—are shown as being part of an actor path of the machine learning model (900). In general, the actor path provides a “player” or decision-maker during training. The actor selects an action (here, determining the output of the machine learning model) based on a policy, as reflected in the configuration of the neural network.

In the machine learning model (900) of FIG. 9, a critic path includes another fully connected layer (970), leaky ReLU activation function (972), and output fully connected layer (980). The first fully connected layer (970) in the critic path takes, as inputs, the 2n values of the intermediate state (732) and has 2n neurons. The output fully connected layer (980) in the critic path takes, as inputs, 2n outputs from the previous fully connected layer (970), has 2n neurons, and produces a single output value. In general, the critic path provides an “observer” who grades the performance of the actor. The critic assesses whether being in the state that results from the action selected by the actor is valuable or not valuable. The critic quantifies whether the action is valuable or not valuable using a reward function.

The reward function depends on implementation. In general, the reward function is based on state information that results from concurrent encoding with the first and second video encoders. In some example implementations, the reward function produces a value R and is defined as:

R=c×R_{basic}+d×util−penalty

The weights c and d depend on implementation. For example, c is 7 and d is 10. Alternatively, the weights c and d have other values.

In the reward function, the term util quantifies bit rate utilization. In general, as bit rate utilization increases, the value of the reward function also increases. For example, the term util is calculated as the sum of (a) the ratio of bit rate of encoded data from the first video encoder (to overall available bit rate) and (b) the ratio of bit rate of encoded data from the second video encoder (to overall available bit rate). If the first video encoder uses 40% of the available bit rate, and the second video encoder uses 60% of the available bit rate, the sum is 100%. On the other hand, if the first video encoder uses 10% of the available bit rate, and the second video encoder uses 60% of the available bit rate, the sum is 70%, and bit rate utilization is low. Alternatively, the bit rate utilization term is defined in another way.

In the reward function, the term R_{basic} is defined as:

R_{basic}=((1−QPᵥ)−e×dropᵥ)+f×((1−QPₛ)−g×dropₛ)

The weights e, f, and g depend on implementation. For example, e is 5, f is 3, and g is 5. Alternatively, the weights e, f, and g have other values. The term QPₛ is the average QP value for a first video encoder (e.g., screen content encoder), and the term QPᵥ is the average QP value for a second video encoder (e.g., camera video encoder). QPₛ and QPᵥ are each normalized to a range of 0.0 to 1.0, so that the minimum QP value is 0.0, and so that the maximum QP value (e.g., 51 for H.264/AVC) is 1.0. The average QP values are, for example, the values reported for compression of current pictures by the respective encoders. In general, as an average QP value increases, the value of the reward function decreases. In other words, the value of the reward function decreases as quantization (and hence distortion) increases. Thus, with the util term and QP terms, the reward function attempts to ensure that the respective video encoders compress content up to, but not past, the point that bit rate is fully utilized. As average QP increases past the point that bit rate is fully utilized, bit rate utilization will decrease, and the value of the reward function will decrease due to the higher QP value and the lower util value. On the other hand, a low average QP for an encoder accompanied by low overall bit rate utilization also represents a situation to be avoided, and results in low value of the reward function due to the lower util value (despite the lower QP value). In particular, in some example implementations, the reward function is defined to discourage wasting of bit rate by the screen content encoder. Such waste might happen, for example, if overall bit rate utilization util is low and the average QP for the screen content encoder is also low.

The term dropₛ represents the number of pictures dropped by the first video encoder (e.g., screen content encoder), and the term dropᵥ represents the number of pictures dropped by the second video encoder (e.g., camera video encoder). In general, as the number of dropped pictures for either encoder increases, the value of the reward function decreases. In this way, the reward function accounts for output buffer fullness, for which dropped pictures are a trailing indicator.

The term penalty is used to penalize incorrect decisions by the actor. In general, the value of the reward function decreases as the term penalty increases. For example, the term penalty can decrease the value of the reward function if the machine learning model shifts bit rate from the first video encoder (e.g., screen content encoder) to the second video encoder (e.g., camera video encoder) even when the ratio of bit rate of encoded data from the first video encoder (to overall available bit rate) is high and the content encoded by the first video encoder is complex. As another example, the term penalty can decrease the value of the reward function if the machine learning model shifts bit rate back to the first video encoder (e.g., screen content encoder) from the second video encoder (e.g., camera video encoder) even when the ratio of bit rate of encoded data from the first video encoder (to overall available bit rate) is low and the content encoded by the first video encoder is simple. In practice, the term penalty is applied selectively. During training, many decisions lead to results that are inconclusive or ambiguous, but some decisions are clearly incorrect (e.g., shifting bit rate from a screen content encoder to a camera video encoder when the bit rate of the screen content is high). The video encoder system detects and accounts for clearly incorrect decisions using rules with associated penalty values. For example, the video encoder system applies a rule defined as follows: if the bit rate of screen content is high (e.g., the ratio of encoded data for the screen content to overall available bit rate is higher than a threshold value, or the output buffer for the screen content encoder has a fullness higher than a threshold value), and the decision is to shift more than a threshold amount of bit rate from the screen content encoder to the camera video encoder (e.g., shift_ratio is higher than a threshold value, or shift_ratio increases by more than a threshold difference), the video encoder system includes a value of the penalty term that decreases the value of the reward function.

The training process can use a data set with labels applied automatically based on conditions controlled (such as network bandwidth) when encoding training data and conditions observed (such as bit rates of encoded data, average QP values, distortion measures, dropped pictures) when encoding the training data.

Based on the value of the reward function, the video encoder system adjusts the machine learning model. For example, if one or more neuron weight values or bias values has been adjusted in an iteration of training the machine learning model, and the resulting value of the reward function increases, the video encoder system keeps the adjusted values or increases the magnitude of the previous adjustments in the next iteration of training. On the other hand, if the resulting value of the reward function decreases, the video encoder system reverses the previous adjustments (to neuron weight value(s) and/or bias value(s)) or decreases the magnitude of the previous adjustments in the next iteration of training. In some example implementations, the video encoder system uses a Proximal Policy Optimization (“PPO”) approach to adjust parameters of the machine learning model based on the value of the reward function. Alternatively, the video encoder system can use another approach (such as Actor Critic with Experience Replay (“ACER”) or Trust Region Policy Optimization (“TRPO”)) to adjust parameters of the machine learning model based on the value of the reward function.

In the preceding examples, the machine learning model is trained using a variation of actor-critic reinforcement learning. Alternatively, the machine learning model can be trained using another type of reinforcement learning. Or, the machine learning model can be trained using supervised learning, unsupervised learning, or another variation of machine learning.

E. Example Techniques for Training a Machine Learning Model to Determine a Parameter for Allocating Bit Rate Between Video Streams.

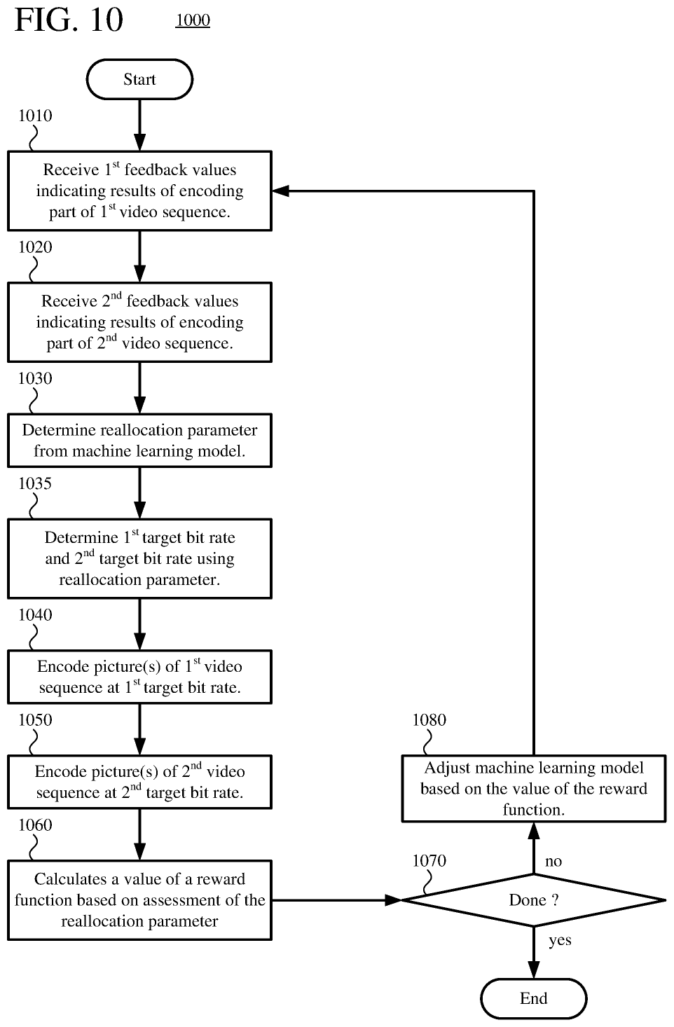

FIG. 10 shows a generalized technique (1000) for training a machine learning model to determine a parameter for allocating bit rate between video streams. A video encoder system such as one described with reference to FIGS. 3 and 4, or another video encoder system, can perform the technique (1000). The technique (1000) uses actor-critic reinforcement learning. The technique (1000) can be performed to train the machine learning model to determine a parameter for allocating bit rate between a screen content stream and camera video stream, or for allocating bit rate between other types of video streams, for a real-time encoding scenario or other encoding scenario.

Many of the operations shown in FIG. 10 are also part of the technique (800, 802) shown in FIG. 8a or 8b. Such operations are explained above and only briefly mentioned in this section.

FIG. 10 shows operations that happen in a single iteration of a training process for the machine learning model. The training process is repeated for multiple iterations.

To start, the video encoder system receives (1010) first feedback values indicating results of encoding part of a first video sequence and also receives (1020) second feedback values indicating results of encoding part of a second video sequence. For additional details, see the explanation for corresponding operations (810, 820) shown in FIG. 8a.

As part of an actor path of the machine learning model, the video encoder system determines (1030) a reallocation parameter from the machine learning model and determines (1035) a first target bit rate and a second target bit rate using the reallocation parameter. For additional details, see the explanation for corresponding operations (830, 832, 834, 836, 838) shown in FIGS. 8a and 8b.

After the first and second target bit rates have been determined, the video encoder system encodes (840) one or more pictures of the first video sequence at the first target bit rate and encodes (850) one or more pictures of the second video sequence at the second target bit rate. For additional details, see the explanation for corresponding operations (840, 850) shown in FIG. 8a.

As part of a critic path of the machine learning model, the video encoder system calculates (1060) a value of a reward function based on assessment of the reallocation parameter. The reward function depends on implementation. Example reward functions are described above. In general, the reward function can depend on a weighted combination of multiple factors. For example, the multiple factors can include a measure of bit rate utilization by a first video encoder and a second video encoder (e.g., the sum of the ratio of available bit rate used by the first video encoder and the ratio of available bit rate used by the second video encoder). Typically, the reward function increases as the bit rate utilization increases. As another example, the multiple factors can include first and second measures of quantization (e.g., average QP) in the encoding with the first video encoder and second video encoder, respectively. Typically, the reward function decreases as a measure of quantization increases. As another example, the multiple factors can include first and second counts of pictures dropped by the first video encoder and second video encoder, respectively. Typically, the reward function decreases as a count of dropped pictures increases. As another example, the multiple factors can include a penalty factor that quantifies an extent of an incorrect determination in the actor path. Typically, the reward function decreases as the penalty factor increases. Alternatively, the reward function depends on other and/or additional types of data.

The video encoder system selectively adjusts the machine learning model based on the value of the reward function. Specifically, the video encoder system checks (1070) whether the training process is done (e.g., done because the neural network has stabilized or because a target number of iterations has been reached in the training process, and the reward function indicates an acceptable outcome). If not, the video encoder system adjusts (1080) the machine learning model based on the value of the reward function. Examples of adjustment are described above.

In some example implementations, the machine learning model uses a neural network that includes an input layer (which accepts the inputs), one or more hidden layers, and an output layer (which produces the output, e.g., reallocation parameter). Examples of such features are described with reference to FIGS. 6, 7, 8a, and 8b. The neural network also includes, for the critic path, an additional hidden layer and output layer. Examples of such features of neural networks are described with reference to FIG. 9.

F. Alternatives and Variations.

This section describes some alternatives to previously described examples and some variations of previously described examples.

Types of content. In many of the examples described herein, a video encoder system dynamically allocates bit rate between a screen content encoder and a camera video encoder. Approaches to dynamic allocation of bit rate as described herein are particularly well-suited for encoding screen content, which often has long periods of static content. Alternatively, operations described herein can be performed by an encoder system when dynamically allocating bit rate between streams of other types of video content (e.g., a stream of animation or other synthetic video content and a camera video stream; multiple streams of camera video content) or, more generally, media content. The machine learning model used to determine the parameter for bit rate allocation can be retrained to work effectively for the different types of streams.

More than two streams. In many of the examples described herein, a video encoder system dynamically allocates bit rate between two streams. Alternatively, a video encoder system can dynamically allocate bit rate between more than two streams, e.g., splitting bit rate borrowed from a first video stream between second and third video streams; or borrowing bit rate from first and second video streams, and allocating the borrowed bit rate to a third video stream.

Encoding scenarios. Approaches to dynamically allocating bit rate between video streams using a machine learning model as described herein are particularly well-suited for real-time encoding scenarios. In real-time encoding scenarios, dynamic bit rate allocation using a machine learning model can improve performance by quickly and accurately predicting bit rate usage. Alternatively, approaches described herein can be used in other encoding scenarios (such as offline encoding, transcoding).

Applications. In some of the examples described herein, approaches to dynamically allocating bit rate between video streams using a machine learning model are used for desktop conferencing or video collaboration meetings. The approaches described herein can be used for other applications such as multi-party online games, gameplay streaming, and broadcasting of multiple video streams.

Reallocation of other constrained resources. In many of the examples described herein, bit rate is dynamically allocated between video streams using a machine learning model. Alternatively, another resource such as a processing resource is dynamically allocated between video streams using a machine learning model. For example, when one or more non-prioritized video streams encounter a constraint for the resource, the video encoder system can automatically borrow the resource from a prioritized video stream while also maintaining specified performance conditions for the prioritized video stream.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. One or more computer-readable media having stored therein computer-executable instructions for causing one or more processors, when programmed thereby, to perform operations comprising:
receiving first feedback values indicating results of encoding part of a first video sequence with a first video encoder;
receiving second feedback values indicating results of encoding part of a second video sequence with a second video encoder;
determining a first target bit rate and a second target bit rate using an output from a machine learning model, wherein the machine learning model accepts, as inputs, the first feedback values and the second feedback values, and wherein the machine learning model produces, as the output, a reallocation parameter;
with the first video encoder, encoding one or more pictures of the first video sequence at the first target bit rate; and
with the second video encoder, encoding one or more pictures of the second video sequence at the second target bit rate.

2. The one or more computer-readable media of claim 1, wherein the first video sequence includes pictures of screen content, and wherein the second video sequence includes pictures of camera video content.

3. The one or more computer-readable media of claim 1, wherein:
the first feedback values include one or more of: (a) a measure of encoded bit rate for the part of the first video sequence; (b) a measure of quantization for the part of the first video sequence; (c) a measure of dropped pictures for the first video sequence; and (d) a measure of buffer fullness for the first video sequence; and
the second feedback values include one or more of: (a) a measure of encoded bit rate for the part of the second video sequence; (b) a measure of quantization for the part of the second video sequence; (c) a measure of dropped pictures for the second video sequence; and (d) a measure of buffer fullness for the second video sequence.

4. The one or more computer-readable media of claim 3, wherein the machine learning model further accepts, as one of the inputs, a measure of total target bit rate for the first video sequence and the second video sequence.

5. The one or more computer-readable media of claim 1, wherein the reallocation parameter is a shift ratio that indicates bit rate to reallocate from the encoding of the first video sequence to the encoding of the second video sequence.

6. The one or more computer-readable media of claim 1, wherein the determining the first target bit rate and the second target bit rate includes:
determining the reallocation parameter as the output from the machine learning model;
calculating the first target bit rate by reducing a first default bit rate based at least in part on the reallocation parameter; and
calculating the second target bit rate by increasing a second default bit rate based at least in part on the reallocation parameter.

7. The one or more computer-readable media of claim 1, wherein the determining the first target bit rate and the second target bit rate further includes:
checking whether the reallocation parameter satisfies a threshold test for triggering reallocation of bit rate from the encoding of the first video sequence to the encoding of the second video sequence.

8. The one or more computer-readable media of claim 1, wherein the machine learning model uses a neural network that includes an input layer, one or more hidden layers, and an output layer, the input layer accepting the inputs, and the output layer producing the reallocation parameter.

9. The one or more computer-readable media of claim 8, wherein each of the one or more hidden layers includes a fully connected layer and uses a leaky rectified linear unit activation function.

10. The one or more computer-readable media of claim 8, wherein the neural network further includes a gated recurrent unit, the gated recurrent unit having a gating mechanism that delays n outputs from a given hidden layer among the one or more hidden layers, and wherein the n outputs from the given hidden layer and the delayed n outputs together provide 2n inputs to a next hidden layer among the one or more hidden layers.

11. The one or more computer-readable media of claim 8, wherein the output layer uses a sigmoid function that produces the reallocation parameter in a range between 0 and 1.

12. The one or more computer-readable media of claim 1, the operations further comprising, during training of the machine learning model using reinforcement learning, in each of multiple iterations:
as part of an actor path of the machine learning model, determining the reallocation parameter;
as part of a critic path of the machine learning model, calculating a value of a reward function based on assessment of the reallocation parameter; and
selectively adjusting the machine learning model based on the value of the reward function.

13. The one or more computer-readable media of claim 12, wherein the reward function depends on a weighted combination of one or more of:
a measure of bit rate utilization by the first video encoder and the second video encoder, wherein the reward function increases as the bit rate utilization increases;
a first measure of quantization by the first video encoder, wherein the reward function decreases as the first measure of quantization increases;
a second measure of quantization by the second video encoder, wherein the reward function decreases as the second measure of quantization increases;
a first count of pictures dropped by the first video encoder, wherein the reward function decreases as the first count of pictures increases;
a second count of pictures dropped by the second video encoder, wherein the reward function decreases as the second count of pictures increases; and
a penalty factor that quantifies an extent of an incorrect determination of the reallocation parameter in the actor path, wherein the reward function decreases as the penalty factor increases.

14. A computer system comprising one or more processors and memory, the computer system implementing a video encoder system comprising:
a controller configured to perform operations comprising:
receiving first feedback values indicating results of encoding part of a first video sequence;
receiving second feedback values indicating results of encoding part of a second video sequence;
determining a first target bit rate and a second target bit rate using an output from a machine learning model, wherein the machine learning model accepts, as inputs, the first feedback values and the second feedback values, and wherein the machine learning model produces, as the output, a reallocation parameter;
a first video encoder configured to encode one or more pictures of the first video sequence at the first target bit rate; and
a second video encoder configured to encode one or more pictures of the second video sequence at the second target bit rate.

15. The computer system of claim 14, wherein the first video encoder is adapted for encoding of screen content, and wherein the second video encoder is adapted for encoding of camera video content.

16. The computer system of claim 14, wherein the reallocation parameter is a shift ratio that indicates bit rate to reallocate from the encoding of the first video sequence to the encoding of the second video sequence, and wherein the determining the first target bit rate and the second target bit rate includes:
determining the reallocation parameter as the output from the machine learning model;
calculating the first target bit rate by reducing a first default bit rate based at least in part on the reallocation parameter; and
calculating the second target bit rate by increasing a second default bit rate based at least in part on the reallocation parameter.

17. The computer system of claim 14, wherein the machine learning model uses a neural network that includes an input layer, one or more hidden layers, and an output layer, the input layer accepting the inputs, and the output layer producing the reallocation parameter.

18. The computer system of claim 14, the operations further comprising, during training of the machine learning model using reinforcement learning, in each of multiple iterations:
as part of an actor path of the machine learning model, determining the reallocation parameter;
as part of a critic path of the machine learning model, calculating a value of a reward function based on assessment of the reallocation parameter; and
selectively adjusting the machine learning model based on the value of the reward function.

19. In a computer system that includes one or more processors and memory, a method of training a machine learning model using reinforcement learning, the method comprising, in each of multiple iterations of the training:
receiving first feedback values indicating results of encoding part of a first video sequence;
receiving second feedback values indicating results of encoding part of a second video sequence;
as part of an actor path of the machine learning model, determining a reallocation parameter, wherein the machine learning model accepts, as inputs, the first feedback values and the second feedback values;
determining a first target bit rate and a second target bit rate using the reallocation parameter;
encoding one or more pictures of the first video sequence at the first target bit rate;
encoding one or more pictures of the second video sequence at the second target bit rate;
as part of a critic path of the machine learning model, calculating a value of a reward function based on assessment of the reallocation parameter; and
selectively adjusting the machine learning model based on the value of the reward function.

20. The method of claim 19, wherein the reward function depends on a weighted combination of one or more of:
a measure of bit rate utilization by a first video encoder and a second video encoder, wherein the reward function increases as the bit rate utilization increases;
a first measure of quantization in the encoding with the first video encoder, wherein the reward function decreases as the first measure of quantization increases;
a second measure of quantization in the encoding with the second video encoder, wherein the reward function decreases as the second measure of quantization increases;
a first count of pictures dropped by the first video encoder, wherein the reward function decreases as the first count of pictures dropped increases;
a second count of pictures dropped by the second video encoder, wherein the reward function decreases as the second count of pictures dropped increases; and
a penalty factor that quantifies an extent of an incorrect determination in the actor path, wherein the reward function decreases as the penalty factor increases.
